(19) United States
(12) Patent Application Publication
(10) Pub. No.: US 2025/0020263 A1
(43) Pub. Date: Jan. 16, 2025

(54) VACUUM ADIABATIC BODY AND METHOD FOR MANUFACTURING THE SAME

(71) Applicant: LG ELECTRONICS INC., Seoul (KR)

(72) Inventors: Wonyeong JUNG, Seoul (KR); Deokhyun YOUN, Seoul (KR); Sungsub LEE, Seoul (KR)

(21) Appl. No.: 18/715,286

(22) PCT Filed: Dec. 1, 2022
(86) PCT No.: PCT/KR2022/019353

§ 371 Date: May 31, 2024

(30) Foreign Application Priority Data
Dec. 3, 2021 (KR) 10-2021-0171926

(51) Int. Cl. F16L 59/065; F25D 23/06

(52) U.S. Cl. CPC F16L 59/065; F25D 23/06; F25D 2201/14

(57) ABSTRACT

A vacuum adiabatic body of the present disclosure may include a first plate; a second plate; and a seal configured to seal the first plate and the second plate to provide a vacuum space. Optionally, the vacuum adiabatic body may include a radiation resistance sheet provided in the vacuum space.

### BACKGROUND OF THE INVENTION

### 1. Field of the Invention

The present disclosure relates to a vacuum adiabatic body, and a method for manufacturing the same.

### 2. Description of Related Art

A vacuum adiabatic wall may be provided to improve adiabatic performance. A device of which at least a portion of an internal space is provided in a vacuum state to achieve an adiabatic effect is referred to as a vacuum adiabatic body.

The applicant has developed a technology to obtain a vacuum adiabatic body that is capable of being used in various devices and home appliances and has disclosed Korean Application Nos. 10-2015-0109724 and 10-2015-0109722 that relate to the vacuum adiabatic body.

In the cited document, a plurality of members are coupled to provide a vacuum space. Specifically, a first plate, a conductive resistance sheet, a side plate, and a second plate are sealed to each other. To seal the coupling portion of each member, a sealing process is performed. A small process error occurring in the sealing process leads to vacuum breakage.

### BRIEF SUMMARY OF THE INVENTION

The present disclosure is to solve the above problems and proposes a vacuum adiabatic body with improved reliability. Various technical problems of the present disclosure are disclosed in detail in the description of the embodiments.

The vacuum adiabatic body of the present disclosure may include a first plate; a second plate; and a vacuum space provided between the first plate and the second plate. Optionally, the vacuum adiabatic body may include a seal configured to seal the first plate and the second plate so as to provide the vacuum space.

Optionally, the vacuum space may include a radiation resistance sheet to resist radiation heat transfer.

Optionally, the radiation resistance sheet may be provided long in one direction. The radiation resistance sheet may extend in a longitudinal direction of the vacuum adiabatic body. The radiation resistance sheet may have a flat portion. Optionally, the center of curvature of the radiation resistance sheet may be placed in the same direction as at least one of the first and second plates. Optionally, a radius of curvature of the radiation resistance sheet may be greater than a radius of curvature of at least one of the first and second plates.

Optionally, the radiation resistance sheet may be separated into at least two components in one direction. Optionally, the radiation resistance sheet may be separated into at least two components in the direction of gravity.

Optionally, the radiation resistance sheet may be thicker than the first plate. Optionally, the radiation resistance sheet may be thinner than the second plate. The radiation resistance sheet may be thicker than the first plate and thinner than the second plate. Optionally, the radiation resistance sheet may have the same thickness as the second plate.

Optionally, the first plate may include a first surface and a second surface for forming a predetermined thickness, and the first surface may be disposed in a direction facing the vacuum space. The support may be disposed to face the first surface. The support may include a bar extending in the thickness direction of the vacuum adiabatic body. The radiation resistance sheet may have at least two types of through-holes into which the bar is inserted. Optionally, the two types of through-holes may have different sizes. Optionally, the two types of through-holes may have different shapes. Optionally, the radiation resistance sheet may include three types of through-holes into which the bar is inserted. Optionally, the three types of through-holes may have different sizes. Optionally, the three types of through-holes may have different shapes.

Optionally, the radiation resistance sheet may include at least two of a first hole H1 having the largest size, a second hole H2 having a medium size, and a third hole H3 having the smallest size. Optionally, the size L1 of the first hole H1 may be greater than the size L2 of the second hole. Optionally, the third hole H3 may have a major axis L3 and a minor axis S3. Optionally, the third hole H3 may have a major axis L3 and a minor axis S3, and the minor axis S3 of the third hole may be the smallest among the holes of the radiation resistance sheet. Optionally, the third hole H3 may have a major axis L3 and a minor axis S3, and the major axis L3 of the third hole may be larger than the second hole L2. Optionally, the third hole H3 may have a major axis L3 and a minor axis S3, and the major axis L3 of the third hole may be provided in a curvature direction of the vacuum adiabatic body. Optionally, the third hole H3 may have a major axis L3 and a minor axis S3, and the major axis L3 of the third hole may be provided in a direction perpendicular to gravity.

Optionally, the first plate may include a first surface and a second surface for forming a predetermined thickness, and the first surface may be disposed in a direction facing the vacuum space. The support may be disposed to face the first surface. The support may include a bar extending in the thickness direction of the vacuum adiabatic body. The bar may include a first bar having a large-diameter portion. The bar may include a second bar having a small-diameter portion which is smaller than the large-diameter portion. The first bar and the second bar may be spaced apart from each other. At least one bar may have the first bar and the second bar as a component. A bar passing through the hole may be included, and a large-diameter portion of the bar may be inserted into the first hole H1. Optionally, a bar passing through the hole may be included, and a small-diameter portion of the bar may be inserted into at least one of the second hole H2 and the third hole H3.

In the present disclosure, the central portion of the object may be defined as a central portion among the three divided portions when the object is divided into thirds based on the longitudinal direction of the object. The peripheral portion of the object may be defined as a portion located to the left or right of the central portion among the three divided portions. The central portion and the peripheral portion may each have its own peripheral portion and its own central portion. For example, the central portion may have its own central portion and its own peripheral portion. Optionally, based on the left and right direction (for example, the direction perpendicular to gravity), the first hole H1 may be placed at the central portion and the peripheral portion of the radiation resistance sheet. The first hole H1 may be placed in the central portion A of the central portion of the radiation resistance sheet. The first hole H1 may be placed in the outer peripheral portion B far from the central portion A among the two peripheral portions of the peripheral portion. Optionally, at least one second hole and at least one third hole may be alternately placed between the central portion and the peripheral portion of the radiation resistance sheet. Optionally, at least one second hole and at least one third hole may be alternately placed based on the vertical direction (for example, the direction of gravity). Optionally, based on the left and right direction, the first hole H1 may be disposed at both ends b of the radiation resistance sheet. Optionally, a second hole H2 and a third hole H3 may be placed in the center a of the radiation resistance sheet. Optionally, a first hole H1 may be placed between both ends b and the center a of the radiation resistance sheet.

A method for manufacturing a vacuum adiabatic body having a seal which seals a first plate and the second plate to provide the first plate, the second plate, and a vacuum seal, may include a vacuum adiabatic body component preparation step of manufacturing a component applied to the vacuum adiabatic body; a vacuum adiabatic body component assembly step of assembling the component; a vacuum adiabatic body component sealing step of sealing an outer wall of the vacuum space to block the vacuum space from the external space; a vacuum adiabatic body vacuum exhausting step of exhausting the internal air of the vacuum space; and a device assembly step of providing a device using the vacuum adiabatic body.

Optionally, in the vacuum adiabatic body vacuum exhausting step, the vacuum adiabatic body may be bent. Optionally, by bending the vacuum adiabatic body, the center of curvature C1 of the first plate and the center of curvature C2 of the second plate are placed in the same direction. Optionally, by bending the vacuum adiabatic body, the distance to the center of curvature C1 of the first plate in the first plate is provided longer than the distance to the center of curvature C2 of the second plate in the second plate.

Optionally, the method for manufacturing a vacuum adiabatic body may further include a radiation resistance sheet provided in the vacuum space, in which the peripheral portion of the radiation resistance sheet may move more along the support in the vacuum adiabatic body component assembling step than in the central portion.

The vacuum adiabatic body of the present disclosure may include, a first plate provided as a wall defining a vacuum space; a second plate connected to the first plate; and a radiation resistance sheet provided in at least a portion of the vacuum space

Optionally, the vacuum adiabatic body includes a portion in which the degree of resistance to heat transfer by radiation is greater than at least a portion of the first plate and the second plate. Optionally, at least a portion of the first plate and the second plate is provided to have a curvature, Optionally, the radiation resistance sheet includes a portion having a curvature, Optionally, the center of curvature of the portion having the curvature of the radiation resistance sheet is in the same direction as the center of curvature of at least a portion of the first plate and the second plate. Optionally, the radius of curvature of the portion having the curvature of the radiation resistance sheet includes a portion greater than the radius of curvature of at least a portion of the first plate and the second plate.

The vacuum adiabatic body of the present disclosure may include a first plate provided as a wall defining a vacuum space; a second plate connected to the first plate; and a radiation resistance sheet provided in at least a portion of the vacuum space. Optionally, the vacuum adiabatic body includes a portion in which the degree of resistance to heat transfer by radiation is greater than at least a portion of the first plate and the second plate. optionally, at least a portion of the first plate and the second plate is provided to have a curvature, and the radiation resistance sheet includes a portion having no curvature.

The vacuum adiabatic body of the present disclosure may include a first plate provided as a wall defining a vacuum space; a second plate connected to the first plate; and a radiation resistance sheet provided in at least a portion of the vacuum space. Optionally, the vacuum adiabatic body includes a portion in which the degree of resistance to heat transfer by radiation is greater than at least a portion of the first plate and the second plate. Optionally, the vacuum adiabatic body includes a support provided on at least a portion of the vacuum adiabatic body and thus provided to maintain the vacuum space. Optionally, the radiation resistance sheet includes a hole through which at least a portion of the support passes, and the hole includes a first hole disposed at a first position and a second hole disposed at a second position different from the first position.

Optionally, the first hole is disposed in a central portion of the radiation resistance sheet. Optionally, the second hole is disposed in a peripheral portion of the radiation resistance sheet. Optionally, the first plate includes a portion in which a distance from the first hole is smaller that a distance from the second hole.

Optionally, the first hole is disposed in a central portion of the radiation resistance sheet. Optionally, the second hole is disposed in a peripheral portion of the radiation resistance sheet. Optionally, the minimum distance between the first plate and the first hole is provided to be smaller than the minimum distance between the first plate and the second hole.

Optionally, the first hole is disposed closer to the center of the radiation resistance sheet than the second hole. Optionally, the first plate includes a portion in which a distance from the first hole is smaller than a distance to the second hole.

Optionally, the first hole is disposed closer to the center of the radiation resistance sheet than the second hole. Optionally, the minimum distance between the first plate and the first hole is provided to be smaller than the minimum distance between the first plate and the second hole.

Optionally, at least a portion of the first plate and the second plate is provided to have a curvature. Optionally, at least a portion of the first plate has a first center of curvature. Optionally, at least a portion of the second plate has a second center of curvature.

Optionally, the first center of curvature and the second center of curvature are provided in the same direction.

Optionally, the distance between a portion having the curvature of the first plate and the first center of curvature is provided to be smaller than the distance between the portion having the curvature of the second plate and the second center of curvature.

Optionally, the first hole is disposed in a central portion of the radiation resistance sheet. Optionally, the second hole is disposed in a peripheral portion of the radiation resistance sheet. Optionally, the inner circumference of the first hole is longer than the inner circumference of the second hole.

Optionally, the first hole is disposed in a central portion of the radiation resistance sheet. Optionally, the second hole is disposed in a peripheral portion of the radiation resistance sheet. Optionally, at least a portion of the first hole and the second hole is provided in an open loop shape.

Optionally, the first hole is disposed closer to the center of the radiation resistance sheet than the second hole. Optionally, the inner circumference of the first hole includes a portion longer than the inner circumference of the second hole.

Optionally, the first hole is disposed in a central portion of the radiation resistance sheet. Optionally, the second hole is disposed in a peripheral portion of the radiation resistance sheet. Optionally, at least a portion of the first hole and the second hole is provided in an open loop shape.

Optionally, the first hole is disposed in a central portion of the radiation resistance sheet. Optionally, the second hole is disposed in a peripheral portion of the radiation resistance sheet. Optionally, at least one of distances between the outer circumference of the support and an inner circumference of the first hole is provided to be greater than at least one of distances between a circumference of the second hole and an inner circumference of the first hole.

Optionally, the first hole is disposed in the central portion of the radiation resistance sheet. Optionally, the second hole is disposed in the peripheral portion of the radiation resistance sheet. Optionally, at least one of distances between the outer circumference of the support and the second hole is provided to be greater than at least one of distances between the outer circumference of the support and the first hole.

Optionally, the first hole is disposed in a central portion of the radiation resistance sheet. Optionally, the second hole is disposed in a peripheral portion of the radiation resistance sheet. Optionally, a third hole is provided between the first hole and the second hole. Optionally, at least one of distances between the outer circumference of the support and the third hole is provide to be different from at least one of distances between the outer circumference of the support and the first hole and at least one of distances between the outer circumference of the support and the second hole.

Optionally, at least one of distances between the outer circumference of the support and the third hole is provide to be smaller than at least one of distances between the outer circumference of the support and the first hole and at least one of distances between the outer circumference of the support and the second hole.

Optionally, the first hole is disposed closer to the center of the radiation resistance sheet than the second hole. Optionally, at least one of distances between the outer circumference of the support and an inner circumference of the first hole is provided to be greater than at least one of the distances between the outer circumference of the second hole and the inner circumference of the second hole.

Optionally, the first hole is disposed closer to the center of the radiation resistance sheet than the second hole. Optionally, at least one of distances between the outer circumference of the support and an inner circumference of the first hole is provided to be greater than at least one of the distances between the outer circumference of the second hole and the inner circumference of the second hole.

Optionally, the first hole is disposed closer to the center of the radiation resistance sheet than the second hole. Optionally, a third hole is provided between the first hole and the second hole.

Optionally, at least one of distances between the outer circumference of the support and the third hole is provided to be different from at least one of distances between the outer circumference of the support and the first hole and at least one of distances between the outer circumference of the support and the second hole.

Optionally, at least one of distances between the outer circumference of the support and the third hole is provided to be smaller than at least one of distances between the outer circumference of the support and the first hole and a distance between the outer circumference of the support and the second hole.

The vacuum adiabatic body according to the present disclosure can maintain an adiabatic effect for a long time. Various effects of the present disclosure are disclosed in more detail in the description of the embodiments.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a perspective view of a refrigerator according to an embodiment.

FIG. 2 is a view schematically illustrating a vacuum adiabatic body used in a body and a door of the refrigerator.

FIG. 3 is a view illustrating an example of a support that maintains a vacuum space.

FIG. 4 is a view for explaining an example of the vacuum with respect to a heat transfer resistor.

FIG. 5 is a graph illustrating results obtained by observing a process of exhausting the inside of the vacuum adiabatic body with a time and pressure when the support is used.

FIG. 6 is a graph illustrating results obtained by comparing a vacuum pressure to gas conductivity.

FIG. 7 is a view illustrating various examples of the vacuum space.

FIG. 8 is a view for explaining another adiabatic body.

FIG. 9 is a view for explaining a heat transfer path between first and second plates having different temperatures.

FIG. 10 is a view for explaining a branch portion on the heat transfer path between first and second plates having different temperatures.

FIG. 11 is a view for explaining a method for manufacturing a vacuum adiabatic body.

FIG. 12 is an enlarged perspective view illustrating an upper side of a corner portion in which a tube is installed in the vacuum adiabatic body.

FIG. 13 is a view for explaining a method of processing a through-hole of the first plate.

FIG. 14 is a cross-sectional view taken along line 1-1′ of (b) of FIG. 12.

FIG. 15 illustrates an example in which a flange extends toward the outside of the vacuum space.

FIGS. 16 to 18 are views for explaining a method for manufacturing a vacuum adiabatic body.

FIG. 19 is a plan view illustrating the vacuum adiabatic body of the embodiment.

FIG. 20 is a cross-sectional view taken along line 1-1′ of FIG. 19.

FIG. 21 is a view illustrating a state of observing an example of the radiation resistance sheet in a direction perpendicular to gravity.

FIG. 22 is a view illustrating a state of observing another example of the radiation resistance sheet in a direction perpendicular to gravity.

FIG. 23 is a partially cut perspective view illustrating the vacuum adiabatic body in the left and right direction.

FIG. 24 is a view for explaining the radius of curvature of the first plate and the second plate.

### DETAILED DESCRIPTION OF THE INVENTION

Hereinafter, specific embodiments will be described in detail with reference to the accompanying drawings. The disclosure may, however, be embodied in many different forms and should not be construed as being limited to the embodiments set forth herein, and a person of ordinary skill in the art, who understands the spirit of the present disclosure, may readily implement other embodiments included within the scope of the same concept by adding, changing, deleting, and adding components; rather, it will be understood that they are also included within the scope of the present disclosure. The present disclosure may have many embodiments in which the idea is implemented, and in each embodiment, any portion may be replaced with a corresponding portion or a portion having a related action according to another embodiment. The present disclosure may be any one of the examples presented below or a combination of two or more examples.

The present disclosure relates to a vacuum adiabatic body including a first plate; a second plate; a vacuum space defined between the first and second plates; and a seal providing the vacuum space that is in a vacuum state. The vacuum space may be a space in a vacuum state provided in an internal space between the first plate and the second plate. The seal may seal the first plate and the second plate to provide the internal space provided in the vacuum state. The vacuum adiabatic body may optionally include a side plate connecting the first plate to the second plate. In the present disclosure, the expression “plate” may mean at least one of the first and second plates or the side plate. At least a portion of the first and second plates and the side plate may be integrally provided, or at least portions may be sealed to each other. Optionally, the vacuum adiabatic body may include a support that maintains the vacuum space. The vacuum adiabatic body may selectively include a thermal insulator that reduces an amount of heat transfer between a first space provided in vicinity of the first plate and a second space provided in vicinity of the second plate or reduces an amount of heat transfer between the first plate and the second plate. Optionally, the vacuum adiabatic body may include a component coupling portion provided on at least a portion of the plate. Optionally, the vacuum adiabatic body may include another adiabatic body. Another adiabatic body may be provided to be connected to the vacuum adiabatic body. Another adiabatic body may be an adiabatic body having a degree of vacuum, which is equal to or different from a degree of vacuum of the vacuum adiabatic body. Another adiabatic body may be an adiabatic body that does not include a degree of vacuum less than that of the vacuum adiabatic body or a portion that is in a vacuum state therein. In this case, it may be advantageous to connect another object to another adiabatic body.

In the present disclosure, a direction along a wall defining the vacuum space may include a longitudinal direction of the vacuum space and a height direction of the vacuum space. The height direction of the vacuum space may be defined as any one direction among virtual lines connecting the first space to the second space to be described later while passing through the vacuum space. The longitudinal direction of the vacuum space may be defined as a direction perpendicular to the set height direction of the vacuum space. In the present disclosure, that an object A is connected to an object B means that at least a portion of the object A and at least a portion of the object B are directly connected to each other, or that at least a portion of the object A and at least a portion of the object B are connected to each other through an intermedium interposed between the objects A and B. The intermedium may be provided on at least one of the object A or the object B. The connection may include that the object A is connected to the intermedium, and the intermedium is connected to the object B. A portion of the intermedium may include a portion connected to either one of the object A and the object B. The other portion of the intermedium may include a portion connected to the other of the object A and the object B. As a modified example, the connection of the object A to the object B may include that the object A and the object B are integrally prepared in a shape connected in the above-described manner. In the present disclosure, an embodiment of the connection may be support, combine, or a seal, which will be described later. In the present disclosure, that the object A is supported by the object B means that the object A is restricted in movement by the object B in one or more of the +X, −X, +Y, −Y, +Z, and −Z axis directions. In the present disclosure, an embodiment of the support may be the combine or seal, which will be described later. In the present disclosure, that the object A is combined with the object B may define that the object A is restricted in movement by the object B in one or more of the X, Y, and Z-axis directions. In the present disclosure, an embodiment of the combining may be the sealing to be described later. In the present disclosure, that the object A is sealed to the object B may define a state in which movement of a fluid is not allowed at the portion at which the object A and the object B are connected. In the present disclosure, one or more objects, i.e., at least a portion of the object A and the object B, may be defined as including a portion of the object A, the whole of the object A, a portion of the object B, the whole of the object B, a portion of the object A and a portion of the object B, a portion of the object A and the whole of the object B, the whole of the object A and a portion of the object B, and the whole of the object A and the whole of the object B. In the present disclosure, that the plate A may be a wall defining the space A may be defined as that at least a portion of the plate A may be a wall defining at least a portion of the space A. That is, at least a portion of the plate A may be a wall forming the space A, or the plate A may be a wall forming at least a portion of the space A. In the present disclosure, a central portion of the object may be defined as a central portion among three divided portions when the object is divided into three sections based on the longitudinal direction of the object. A peripheral portion of the object may be defined as a portion disposed at a left or right side of the central portion among the three divided portions. The peripheral portion of the object may include a surface that is in contact with the central portion and a surface opposite thereto. The opposite side may be defined as a border or edge of the object. Examples of the object may include a vacuum adiabatic body, a plate, a heat transfer resistor, a support, a vacuum space, and various components to be introduced in the present disclosure. In the present disclosure, a degree of heat transfer resistance may indicate a degree to which an object resists heat transfer and may be defined as a value determined by a shape including a thickness of the object, a material of the object, and a processing method of the object. The degree of the heat transfer resistance may be defined as the sum of a degree of conduction resistance, a degree of radiation resistance, and a degree of convection resistance. The vacuum adiabatic body according to the present disclosure may include a heat transfer path defined between spaces having different temperatures, or a heat transfer path defined between plates having different temperatures. For example, the vacuum adiabatic body according to the present disclosure may include a heat transfer path through which cold is transferred from a low-temperature plate to a high-temperature plate. In the present disclosure, when a curved portion includes a first portion extending in a first direction and a second portion extending in a second direction different from the first direction, the curved portion may be defined as a portion that connects the first portion to the second portion (including 90 degrees).

In the present disclosure, the vacuum adiabatic body may optionally include a component coupling portion. The component coupling portion may be defined as a portion provided on the plate to which components are connected to each other. The component connected to the plate may be defined as a penetration portion disposed to pass through at least a portion of the plate and a surface component disposed to be connected to a surface of at least a portion of the plate. At least one of the penetration component or the surface component may be connected to the component coupling portion. The penetration component may be a component that defines a path through which a fluid (electricity, refrigerant, water, air, etc.) passes mainly. In the present disclosure, the fluid is defined as any kind of flowing material. The fluid includes moving solids, liquids, gases, and electricity. For example, the component may be a component that defines a path through which a refrigerant for heat exchange passes, such as a suction line heat exchanger (SLHX) or a refrigerant tube. The component may be an electric wire that supplies electricity to an apparatus. As another example, the component may be a component that defines a path through which air passes, such as a cold duct, a hot air duct, and an exhaust port. As another example, the component may be a path through which a fluid such as coolant, hot water, ice, and defrost water pass. The surface component may include at least one of a peripheral adiabatic body, a side panel, injected foam, a pre-prepared resin, a hinge, a latch, a basket, a drawer, a shelf, a light, a sensor, an evaporator, a front decor, a hotline, a heater, an exterior cover, or another adiabatic body.

As an example to which the vacuum adiabatic body is applied, the present disclosure may include an apparatus having the vacuum adiabatic body. Examples of the apparatus may include an appliance. Examples of the appliance may include home appliances including a refrigerator, a cooking appliance, a washing machine, a dishwasher, and an air conditioner, etc. As an example in which the vacuum adiabatic body is applied to the apparatus, the vacuum adiabatic body may constitute at least a portion of a body and a door of the apparatus. As an example of the door, the vacuum adiabatic body may constitute at least a portion of a general door and a door-in-door (DID) that is in direct contact with the body. Here, the door-in-door may mean a small door placed inside the general door. As another example to which the vacuum adiabatic body is applied, the present disclosure may include a wall having the vacuum adiabatic body. Examples of the wall may include a wall of a building, which includes a window.

Hereinafter, the present disclosure will be described in detail with reference to the accompanying drawings. Each of the drawings accompanying the embodiment may be different from, exaggerated, or simply indicated from an actual article, and detailed components may be indicated with simplified features. The embodiment should not be interpreted as being limited only to the size, structure, and shape presented in the drawings. In the embodiments accompanying each of the drawings, unless the descriptions conflict with each other, some configurations in the drawings of one embodiment may be applied to some configurations of the drawings in another embodiment, and some structures in one embodiment may be applied to some structures in another embodiment. In the description of the drawings for the embodiment, the same reference numerals may be assigned to different drawings as reference numerals of specific components constituting the embodiment. Components having the same reference number may perform the same function. For example, the first plate constituting the vacuum adiabatic body has a portion corresponding to the first space throughout all embodiments and is indicated by reference number 10. The first plate may have the same number for all embodiments and may have a portion corresponding to the first space, but the shape of the first plate may be different in each embodiment. Not only the first plate, but also the side plate, the second plate, and another adiabatic body may be understood as well.

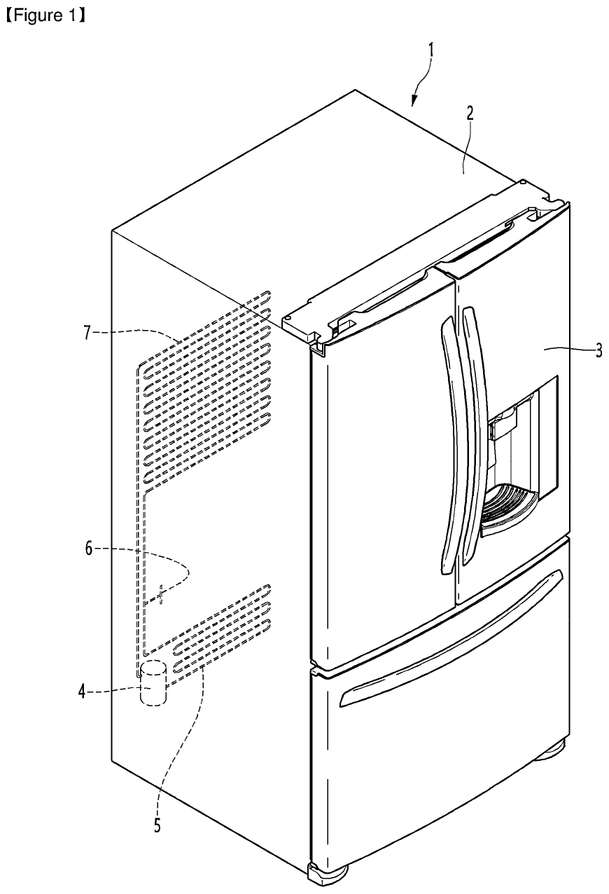

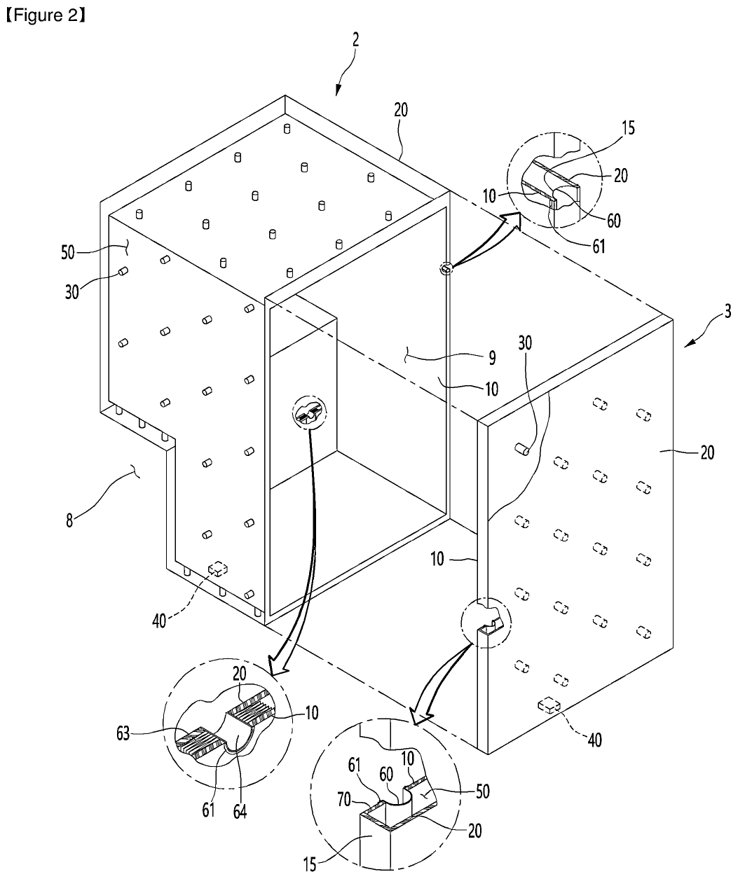

FIG. 1 is a perspective view of a refrigerator according to an embodiment, and FIG. 2 is a schematic view illustrating a vacuum adiabatic body used for a body and a door of the refrigerator. Referring to FIG. 1, the refrigerator 1 includes a main body 2 provided with a cavity 9 capable of storing storage goods and a door 3 provided to open and close the main body 2. The door 3 may be rotatably or slidably disposed to open or close the cavity 9. The cavity 9 may provide at least one of a refrigerating compartment and a freezing compartment. A cold source that supplies cold to the cavity may be provided. For example, the cold source may be an evaporator 7 that evaporates the refrigerant to take heat. The evaporator 7 may be connected to a compressor 4 that compresses the refrigerant evaporated to the cold source. The evaporator 7 may be connected to a condenser 5 that condenses the compressed refrigerant to the cold source. The evaporator 7 may be connected to an expander 6 that expands the refrigerant condensed in the cold source. A fan corresponding to the evaporator and the condenser may be provided to promote heat exchange. As another example, the cold source may be a heat absorption surface of a thermoelectric element. A heat absorption sink may be connected to the heat absorption surface of the thermoelectric element. A heat sink may be connected to a heat radiation surface of the thermoelectric element. A fan corresponding to the heat absorption surface and the heat generation surface may be provided to promote heat exchange.

Referring to FIG. 2, plates 10, 15, and 20 may be walls defining the vacuum space. The plates may be walls that partition the vacuum space from an external space of the vacuum space. An example of the plates is as follows. The present disclosure may be any one of the following examples or a combination of two or more examples.

The plate may be provided as one portion or may be provided to include at least two components connected to each other. The plate may include a first plate 10 and/or a second plate 20. One surface of the first plate (e.g., the inner surface of the first plate) may provide a wall defining the vacuum space, and the other surface (e.g., the outer surface of the first plate) of the first plate may provide a wall defining the first space. The first space may be a space provided in the vicinity of the first plate, a space defined by the apparatus, or an internal space of the apparatus. The second space may be a space provided in vicinity of the second plate, another space defined by the apparatus, or an external space of the apparatus. The side plate may include a portion extending in a height direction of a space defined between the first plate and the second plate or a portion extending in a height direction of the vacuum space. The external space of the vacuum space may be at least one of the first space or the second space or a space in which another adiabatic body to be described later is disposed. The plate may optionally include a curved portion. In the present disclosure, the plate including a curved portion may be referred to as a bent plate.

In the present disclosure, the vacuum space 50 may be defined as a third space. The vacuum space may be a space in which a vacuum pressure is maintained. In the present disclosure, the expression that a vacuum degree of A is higher than that of B means that a vacuum pressure of A is lower than that of B.

In the present disclosure, the seal 61 may be a portion provided between the first plate and the second plate. Examples of sealing are as follows. The present disclosure may be any one of the following examples or a combination of two or more examples. The sealing may include fusion welding for coupling the plurality of objects by melting at least a portion of the plurality of objects. For example, the first plate and the second plate may be welded by laser welding in a state in which a melting bond such as a filler metal is not interposed therebetween, a portion of the first and second plates and a portion of the component coupling portion may be welded by high-frequency brazing or the like, or a plurality of objects may be welded by a melting bond that generates heat. The sealing may include pressure welding for coupling the plurality of objects by a mechanical pressure applied to at least a portion of the plurality of objects. For example, as a component connected to the component coupling portion, an object made of a material having a degree of deformation resistance less than that of the plate may be pressure-coupling or pressure-welding by a method such as pinch-off or etc.

A machine room 8 may be optionally provided outside the vacuum adiabatic body. The machine room may be defined as a space in which components connected to the cold source are accommodated. Optionally, the vacuum adiabatic body may include a port 40. The port may be provided at at least any one side of the vacuum adiabatic body to discharge air of the vacuum space 50. Optionally, the vacuum adiabatic body may include a conduit 64 passing through the vacuum space 50 to install components connected to the first space and the second space.

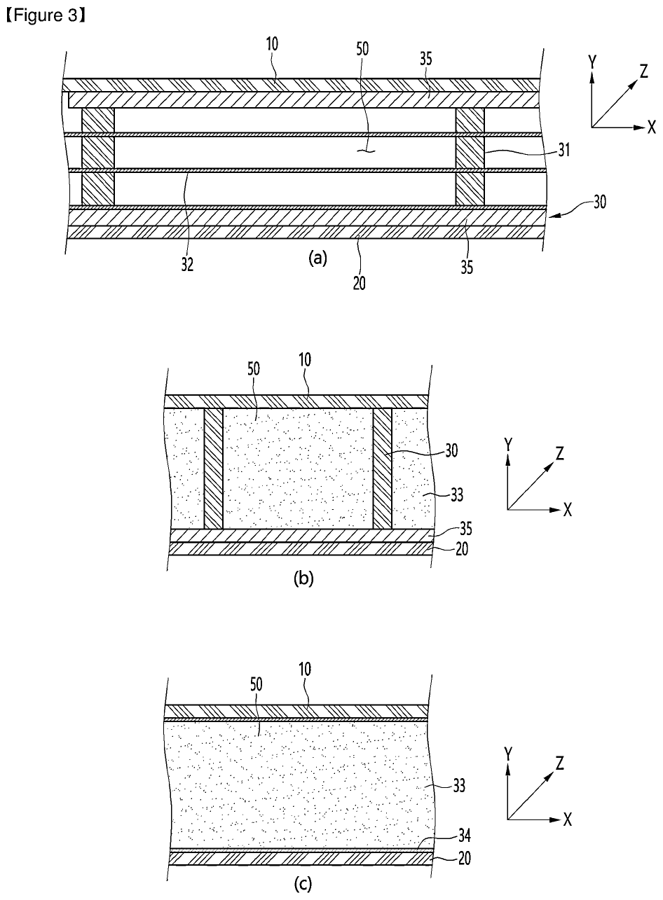

FIG. 3 is a view illustrating an example of a support that maintains the vacuum space. An example of the support is as follows. The present disclosure may be any one of the following examples or a combination of two or more examples.

The supports 30, 31, 33, and 35 may be provided to support at least a portion of the plate and a heat transfer resistor to be described later, thereby reducing deformation of at least some of the vacuum space 50, the plate, and the heat transfer resistor to be described later due to external force. The external force may include at least one of a vacuum pressure or external force excluding the vacuum pressure. When the deformation occurs in a direction in which a height of the vacuum space is lower, the support may reduce an increase in at least one of radiant heat conduction, gas heat conduction, surface heat conduction, or support heat conduction, which will be described later. The support may be an object provided to maintain a gap between the first plate and the second plate or an object provided to support the heat transfer resistor. The support may have a degree of deformation resistance greater than that of the plate, or be provided to a portion having weak degree of deformation resistance among portions constituting the vacuum adiabatic body, the apparatus having the vacuum adiabatic body, and the wall having the vacuum adiabatic body. According to an embodiment, a degree of deformation resistance represents a degree to which an object resists deformation due to external force applied to the object and is a value determined by a shape including a thickness of the object, a material of the object, a processing method of the object, and the like. Examples of the portions having the weak degree of deformation resistance include the vicinity of the curved portion defined by the plate, at least a portion of the curved portion, the vicinity of an opening defined in the body of the apparatus, which is provided by the plate, or at least a portion of the opening. The support may be disposed to surround at least a portion of the curved portion or the opening or may be provided to correspond to the shape of the curved portion or the opening. However, it is not excluded that the support is provided in other portions. The opening may be understood as a portion of the apparatus including the body and the door capable of opening or closing the opening defined in the body.

An example in which the support is provided to support the plate is as follows. First, at least a portion of the support may be provided in a space defined inside the plate. The plate may include a portion including a plurality of layers, and the support may be provided between the plurality of layers. Optionally, the support may be provided to be connected to at least a portion of the plurality of layers or be provided to support at least a portion of the plurality of layers. Second, at least a portion of the support may be provided to be connected to a surface defined on the outside of the plate. The support may be provided in the vacuum space or an external space of the vacuum space. For example, the plate may include a plurality of layers, and the support may be provided as any one of the plurality of layers. Optionally, the support may be provided to support the other one of the plurality of layers. For example, the plate may include a plurality of portions extending in the longitudinal direction, and the support may be provided as at least any one of the plurality of portions. Optionally, the support may be provided to support the other one of the plurality of parts. As further another example, the support may be provided in the vacuum space or the external space of the vacuum space as a separate component, which is distinguished from the plate. Optionally, the support may be provided to support at least a portion of a surface defined on the outside of the plate. Optionally, the support may be provided to support one surface of the first plate and one surface of the second plate, and the one surface of the first plate and the one surface of the second plate may be provided to face each other. Third, the support may be provided to be integrated with the plate. An example in which the support is provided to support the heat transfer resistor may be understood instead of the example in which the support is provided to support the plate. A duplicated description will be omitted.

An example of the support in which heat transfer through the support is designed to be reduced is as follows. First, at least a portion of the components disposed in the vicinity of the support may be provided so as not to be in contact with the support or provided in an empty space provided by the support. Examples of the components include a tube or component connected to the heat transfer resistor to be described later, an exhaust port, a getter port, a tube or component passing through the vacuum space, or a tube or component of which at least a portion is disposed in the vacuum space. Examples of the empty space may include an empty space provided in the support, an empty space provided between the plurality of supports, and an empty space provided between the support and a separate component that is distinguished from the support. Optionally, at least a portion of the component may be disposed in a through-hole defined in the support, be disposed between the plurality of bars, be disposed between the plurality of connection plates, or be disposed between the plurality of support plates. Optionally, at least a portion of the component may be disposed in a spaced space between the plurality bars, be disposed in a spaced space between the plurality of connection plates, or be disposed in a spaced space between the plurality of support plates. Second, an adiabatic body may be provided on at least a portion of the support or in the vicinity of at least a portion of the support. The adiabatic body may be provided to be in contact with the support or provided so as not to be in contact with the support. The adiabatic body may be provided at a portion in which the support and the plate are in contact with each other. The adiabatic body may be provided on at least a portion of one surface and the other surface of the support or be provided to cover at least a portion of one surface and the other surface of the support. The adiabatic body may be provided on at least a portion of an adjacent portion of one surface of the support and an adjacent portion of the other surface of the support, or be provided to cover at least a portion of an adjacent portion of one surface of the support and an adjacent portion of the other surface of the support. The support may include a plurality of bars, and the adiabatic body may be disposed on an area from a point at which any one of the plurality of bars is disposed to a midpoint between the one bar and the surrounding bars. Third, when cold is transferred through the support, a heat source may be disposed at a position at which the heat adiabatic body described in the second example is disposed. When a temperature of the first space is lower than a temperature of the second space, the heat source may be disposed on the second plate or in the vicinity of the second plate. When heat is transmitted through the support, a cold source may be disposed at a position at which the heat adiabatic body described in the second example is disposed. When a temperature of the first space is higher than a temperature of the second space, the cold source may be disposed on the second plate or in the vicinity of the second plate. As fourth example, the support may include a portion having heat transfer resistance higher than a metal or a portion having heat transfer resistance higher than the plate. The support may include a portion having heat transfer resistance less than that of another adiabatic body. The support may include at least one of a non-metal material, PPS, and glass fiber (GF), low outgassing PC, PPS, or LCP. This is done for a reason in which high compressive strength, low outgassing, and a water absorption rate, low thermal conductivity, high compressive strength at a high temperature, and excellent workability are being capable of obtained.

Examples of the support may be the bars 30 and 31, the connection plate 35, the support plate 35, a porous material 33, and/or a filler 33. In this embodiment, the support may include at least any one of the above examples, or an example in which at least two examples are combined. As first example, the support may include bars 30 and 31. The bar may include a portion extending in a direction in which the first plate and the second plate are connected to each other to support a gap between the first plate and the second plate. The bar may include a portion extending in a height direction of the vacuum space or a portion extending in a direction that is substantially perpendicular to the direction in which the plate extends. The bar may be provided to support only one of the first plate and the second plate or may be provided both the first plate and the second plate. For example, one surface of the bar may be provided to support a portion of the plate, and the other surface of the bar may be provided so as not to be in contact with the other portion of the plate. As another example, one surface of the bar may be provided to support at least a portion of the plate, and the other surface of the bar may be provided to support the other portion of the plate. The support may include a bar having an empty space therein or a plurality of bars. The support may have an empty space are provided between the plurality of bars. The support may include a bar, and the bar may be disposed to provide an empty space between the bar and a separate component that is distinguished from the bar. The support may selectively include a connection plate 35 including a portion connected to the bar or a portion connecting the plurality of bars to each other. The connection plate may include a portion extending in the longitudinal direction of the vacuum space or a portion extending in the direction in which the plate extends. An XZ-plane cross-sectional area of the connection plate may be greater than an XZ-plane cross-sectional area of the bar. The connection plate may be provided on at least one of one surface and the other surface of the bar or may be provided between one surface and the other surface of the bar. At least one of one surface and the other surface of the bar may be a surface on which the bar supports the plate. The shape of the connection plate is not limited. The support may include a connection plate having an empty space therein or a plurality of connection plates, and an empty space are provided between the plurality of connection plates. The support may include a connection plate, and the connection plate may be disposed to provide an empty space between the connection plate and a separate component that is distinguished from the connection plate. As a second example, the support may include a support plate 35. The support plate may include a portion extending in the longitudinal direction of the vacuum space or a portion extending in the direction in which the plate extends. The support plate may be provided to support only one of the first plate and the second plate or may be provided both the first plate and the second plate. For example, one surface of the support plate may be provided to support a portion of the plate, and the other surface of the support plate may be provided so as not to be in contact with the other portion of the plate. As another example, one surface of the support plate may be provided to support at least a portion of the plate, and the other surface of the support plate may be provided to support the other portion of the plate. A cross-sectional shape of the support plate is not limited. The support may include a support plate having an empty space therein or a plurality of support plates, and an empty space are provided between the plurality of support plates. The support may include a support plate, and the support plate may be disposed to provide an empty space between the support plate and a separate component that is distinguished from the support plate. As a third example, the support may include a porous material 33 or a filler 33. The inside of the vacuum space may be supported by the porous material or the filler. The inside of the vacuum space may be completely filled by the porous material or the filler. The support may include a plurality of porous materials or a plurality of fillers, and the plurality of porous materials or the plurality of fillers may be disposed to be in contact with each other. When an empty space is provided inside the porous material, provided between the plurality of porous materials, or provided between the porous material and a separate component that is distinguished from the porous material, the porous material may be understood as including any one of the aforementioned bar, connection plate, and support plate. When an empty space is provided inside the filler, provided between the plurality of fillers, or provided between the filler and a separate component that is distinguished from the filler, the filler may be understood as including any one of the aforementioned bar, connection plate, and support plate. The support according to the present disclosure may include at least any one of the above examples or an example in which two or more examples are combined.

Referring to FIG. 3a, as an embodiment, the support may include a bar 31 and a connection plate and support plate 35. The connection plate and the supporting plate may be designed separately. Referring to FIG. 3b, as an embodiment, the support may include a bar 31, a connection plate and support plate 35, and a porous material 33 filled in the vacuum space. The porous material 33 may have emissivity greater than that of stainless steel, which is a material of the plate, but since the vacuum space is filled, resistance efficiency of radiant heat transfer is high. The porous material may also function as a heat transfer resistor to be described later. More preferably, the porous material may perform a function of a radiation resistance sheet to be described later. Referring to FIG. 3c, as an embodiment, the support may include a porous material 33 or a filler 33. The porous material 33 and the filler may be provided in a compressed state to maintain a gap between the vacuum space. The film 34 may be provided in a state in which a hole is punched as, for example, a PE material. The porous material 33 or the filler may perform both a function of the heat transfer resistor and a function of the support, which will be described later. More preferably, the porous material may perform both a function of the radiation resistance sheet and a function of the support to be described later.

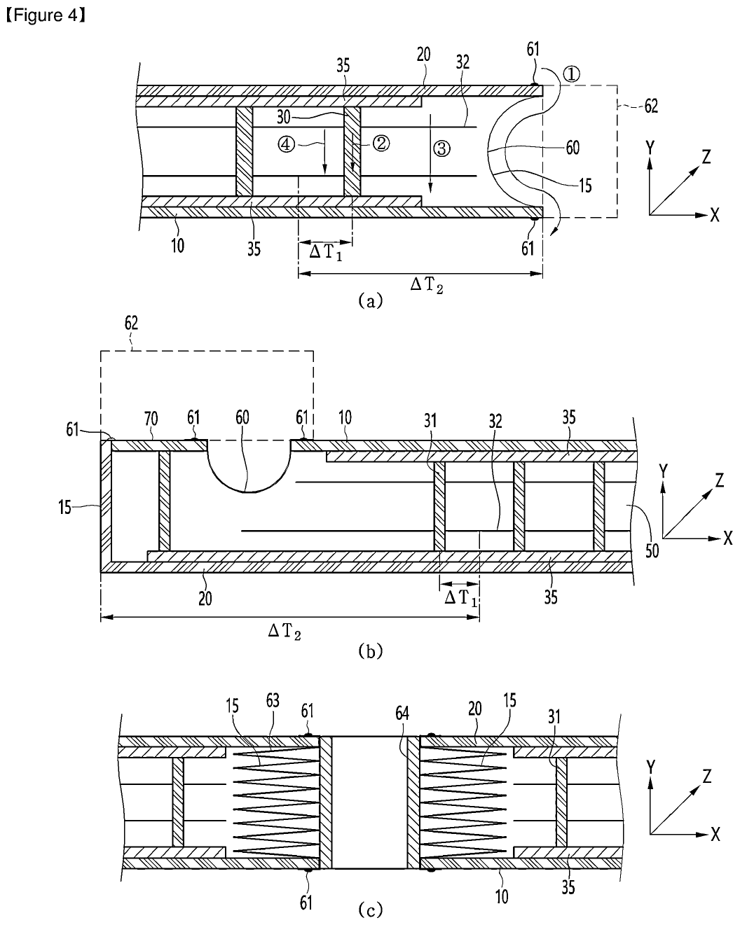

FIG. 4 is a view for explaining an example of the vacuum adiabatic body based on heat transfer resistors 32, 33, 60, and 63 (e.g., thermal insulator and a heat transfer resistance body). The vacuum adiabatic body according to the present disclosure may optionally include a heat transfer resistor. An example of the heat transfer resistor is as follows. The present disclosure may be at least any one of the following examples or a combination of two or more examples.

The heat transfer resistors 32, 33, 60, and 63 may be objects that reduce an amount of heat transfer between the first space and the second space or objects that reduce an amount of heat transfer between the first plate and the second plate. The heat transfer resistor may be disposed on a heat transfer path defined between the first space and the second space or be disposed on a heat transfer path formed between the first plate and the second plate. The heat transfer resistor may include a portion extending in a direction along a wall defining the vacuum space or a portion extending in a direction in which the plate extends. Optionally, the heat transfer resistor may include a portion extending from the plate in a direction away from the vacuum space. The heat transfer resistor may be provided on at least a portion of the peripheral portion of the first plate or the peripheral portion of the second plate or be provided on at least a portion of an edge of the first plate or an edge of the second plate. The heat transfer resistor may be provided at a portion, in which a through-hole is defined, or provided as a tube connected to the through-hole. A separate tube or a separate component that is distinguished from the tube may be disposed inside the tube. The heat transfer resistor may include a portion having heat transfer resistance greater than that of the plate. In this case, adiabatic performance of the vacuum adiabatic body may be further improved. A shield 62 may be provided on the outside of the heat transfer resistor to be insulated. The inside of the heat transfer resistor may be insulated by the vacuum space. The shield may be provided as a porous material or a filler that is in contact with the inside of the heat transfer resistor. The shield may be an adiabatic structure that is exemplified by a separate gasket placed outside the inside of the heat transfer resistor. The heat transfer resistor may be a wall defining the third space.

An example in which the heat transfer resistor is connected to the plate may be understood as replacing the support with the heat transfer resistor in an example in which the support is provided to support the plate. A duplicate description will be omitted. The example in which the heat transfer resistor is connected to the support may be understood as replacing the plate with the support in the example in which the heat transfer resistor is connected to the plate. A duplicate description will be omitted. The example of reducing heat transfer via the heat transfer body may be applied as a substitute the example of reducing the heat transfer via the support, and thus, the same explanation will be omitted.

In the present disclosure, the heat transfer resistor may be at least one of a radiation resistance sheet 32, a porous material 33, a filler 33, and a conductive resistance sheet. In the present disclosure, the heat transfer resistor may include a combination of at least two of the radiation resistance sheet 32, the porous material 33, the filler 33, and the conductive resistance sheet. As a first example, the heat transfer resistor may include a radiation resistance sheet 32. The radiation resistance sheet may include a portion having heat transfer resistance greater than that of the plate. The heat transfer resistance may be a degree of resistance to heat transfer by radiation. The support may perform a function of the radiation resistance sheet together. A conductive resistance sheet to be described later may perform the function of the radiation resistance sheet together. As a second example, the heat transfer resistor may include conduction resistance sheets 60 and 63. The conductive resistance sheet may include a portion having heat transfer resistance greater than that of the plate. The heat transfer resistance may be a degree of resistance to heat transfer by conduction. For example, the conductive resistance sheet may have a thickness less than that of at least a portion of the plate. As another example, the conductive resistance sheet may include one end and the other end, and a length of the conductive resistance sheet may be longer than a straight distance connecting one end of the conductive resistance sheet to the other end of the conductive resistance sheet. As another example, the conductive resistance sheet may include a material having resistance to heat transfer greater than that of the plate by conduction. As another example, the heat transfer resistor may include a portion having a curvature radius less than that of the plate.

Referring to FIG. 4a, for example, a conductive resistance sheet may be provided on a side plate connecting the first plate to the second plate. Referring to FIG. 4b, for example, a conductive resistance sheet 60 may be provided on at least a portion of the first plate and the second plate. A connection frame 70 may be further provided outside the conductive resistance sheet. The connection frame may be a portion from which the first plate or the second plate extends or a portion from which the side plate extends. Optionally, the connection frame 70 may include a portion to which a component for sealing the door and the body and a component disposed outside the vacuum space such as the exhaust port and the getter port, which are required for the exhaust process and for maintaining the vacuum pressure respectively, are connected. Referring to FIG. 4c, for example, a conductive resistance sheet may be provided on a side plate connecting the first plate to the second plate. The conductive resistance sheet may be installed in a through-hole passing through the vacuum space. The conduit 64 may be provided separately outside the conductive resistance sheet. The conductive resistance sheet may be provided in a pleated and/or corrugated shape. Through this, the heat transfer path may be lengthened, and deformation due to a pressure difference may be prevented. A separate shielding member for insulating the conductive resistance sheet 63 may also be provided. The conductive resistance sheet may include a portion having a degree of deformation resistance less than that of at least one of the plate, the radiation resistance sheet, and/or the support. The radiation resistance sheet may include a portion having a degree of deformation resistance less than that of at least one of the plate and the support. The plate may include a portion having a degree of deformation resistance less than that of the support. The conductive resistance sheet may include a portion having conductive heat transfer resistance greater than that of at least one of the plate, the radiation resistance sheet, and/or the support. The radiation resistance sheet may include a portion having radiation heat transfer resistance greater than that of at least one of the plate, the conductive resistance sheet, and/or the support. The support may include a portion having heat transfer resistance greater than that of the plate. For example, at least one of the plate, the conductive resistance sheet, and/or the connection frame may include stainless steel material. The radiation resistance sheet may include aluminum. The support may include a resin material.

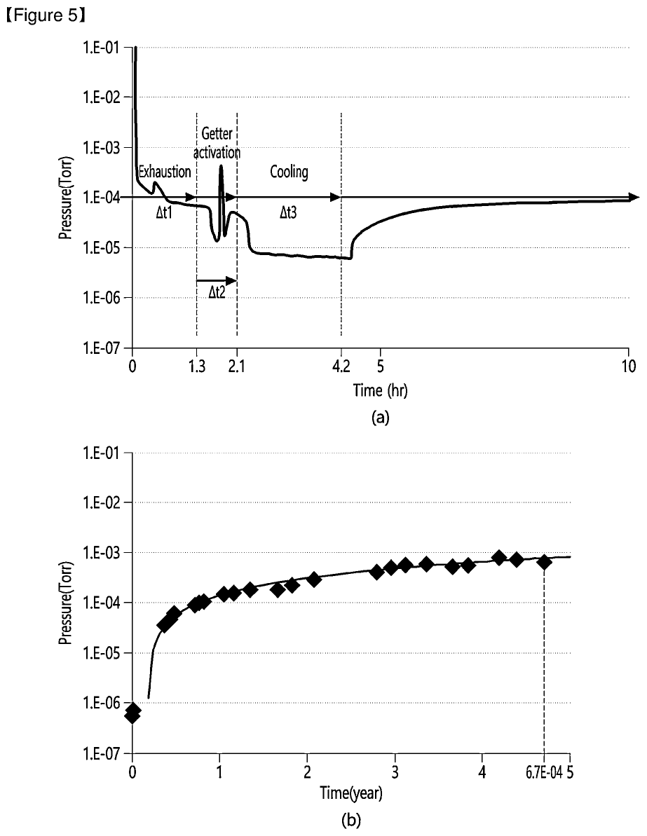

FIG. 5 is a graph for observing a process of exhausting the inside of the vacuum adiabatic body with a time and pressure when the support is used. An example of a vacuum adiabatic body vacuum exhaust process vacuum is as follows. The present disclosure may be at least any one of the following examples or a combination of two or more examples.

While the exhaust process is being performed, an outgassing process, which is a process in which a gas of the vacuum space is discharged, and/or a potential gas remaining in the components of the vacuum adiabatic body is discharged, may be performed. As an example of the outgassing process, the exhaust process may include at least one of heating and/or drying the vacuum adiabatic body, providing a vacuum pressure to the vacuum adiabatic body, and/or providing a getter to the vacuum adiabatic body. The time during which the vacuum adiabatic body vacuum exhaust process is performed may be referred to as a vacuum exhaust time. The vacuum exhaust time includes at least one of a time Δ1 during which the process of heating and/or drying the vacuum adiabatic body is performed, a time Δt2 during which the process of maintaining the getter in the vacuum adiabatic body is performed, and/or a time Δt3 during which the process of cooling the vacuum adiabatic body is performed. Examples of times Δt1, Δt2, and Δt3 are as follows. The present disclosure may be any one of the following examples or a combination of two or more examples. In the vacuum adiabatic body vacuum exhaust process, the time Δt1 may be a time t1a or more and a time t1b or less. As a first example, the time t1a may be greater than or equal to about 0.2 hr and less than or equal to about 0.5 hr. The time t1b may be greater than or equal to about 1 hr and less than or equal to about 24.0 hr. Preferably, the time Δt1 may be about 0.3 hr or more and about 12.0 hr or less. Preferably, the time Δt1 may be about 0.4 hr or more and about 8.0 hr or less. More preferably, the time Δt1 may be about 0.5 hr or more and about 4.0 hr or less. In this case, even if the Δt1 is kept as short as possible, the sufficient outgassing may be applied to the vacuum adiabatic body. For example, this case may include a case in which a component of the vacuum adiabatic body, which is exposed to the vacuum space, among the components of the vacuum adiabatic body, has an outgassing rate (%) less than that of any one of the component of the vacuum adiabatic body, which is exposed to the external space of the vacuum space. Specifically, the component exposed to the vacuum space may include a portion having a outgassing rate less than that of a thermoplastic polymer. More specifically, the support and/or the radiation resistance sheet may be disposed in the vacuum space, and the outgassing rate of the support may be less than that of the thermoplastic plastic. As another example, this case may include a case in which a component of the vacuum adiabatic body, which is exposed to the vacuum space, among the components of the vacuum adiabatic body, has a max operating temperature (° C.) greater than that of any one of the component of the vacuum adiabatic body, which is exposed to the external space of the vacuum space. In this case, the vacuum adiabatic body may be heated to a higher temperature to increase in outgassing rate. For example, the component exposed to the vacuum space may include a portion having an operating temperature greater than that of the thermoplastic polymer. As a more specific example, the support and/or the radiation resistance sheet may be disposed in the vacuum space. The use temperature of the support may be higher than that of the thermoplastic plastic. As another example, among the components of the vacuum adiabatic body, the component exposed to the vacuum space may contain more metallic portion than a non-metallic portion. That is, a mass of the metallic portion may be greater than a mass of the non-metallic portion, a volume of the metallic portion may be greater than a volume of the non-metallic portion, and/or an area of the metallic portion exposed to the vacuum space may be greater than an area exposed to the non-metallic portion of the vacuum space. When the components exposed to the vacuum space are provided in plurality, the sum of the volume of the metal material included in the first component and the volume of the metal material included in the second component may be greater than that of the volume of the non-metal material included in the first component and the volume of the non-metal material included in the second component. When the components exposed to the vacuum space are provided in plurality, the sum of the mass of the metal material included in the first component and the mass of the metal material included in the second component may be greater than that of the mass of the non-metal material included in the first component and the mass of the non-metal material included in the second component. When the components exposed to the vacuum space are provided in plurality, the sum of the area of the metal material, which is exposed to the vacuum space and included in the first component, and an area of the metal material, which is exposed to the vacuum space and included in the second component, may be greater than that of the area of the non-metal material, which is exposed to the vacuum space and included in the first component, and an area of the non-metal material, which is exposed to the vacuum space and included in the second component. As a second example, the time t1a may be greater than or equal to about 0.5 hr and less than or equal to about 1 hr. The time t1b may be greater than or equal to about 24.0 hr and less than or equal to about 65 hr. Preferably, the time Δt1 may be about 1.0 hr or more and about 48.0 hr or less. Preferably, the time Δt1 may be about 2 hr or more and about 24.0 hr or less. More preferably, the time Δt1 may be about 3 hr or more and about 12.0 hr or less. In this case, it may be the vacuum adiabatic body that needs to maintain the Δt1 as long as possible. In this case, a case opposite to the examples described in the first example or a case in which the component exposed to the vacuum space is made of a thermoplastic material may be an example. A duplicated description will be omitted. In the vacuum exhaust process of the vacuum adiabatic body, the time Δt2 may be a time t2a or more and a time t2b or less. The time t2a may be greater than or equal to about 0.1 hr and less than or equal to about 0.3 hr. The time t2b may be greater than or equal to about 1 hr and less than or equal to about 5.0 hr. Preferably, the time Δt2 may be about 0.2 hr or more and about 3.0 hr or less. More preferably, the time Δt2 may be about 0.3 hr or more and about 2.0 hr or less. More preferably, the time Δt2 may be about 0.5 hr or more and about 1.5 hr or less. In this case, even if the time Δt2 is kept as short as possible, the sufficient outgassing through the getter may be applied to the vacuum adiabatic body. In the vacuum exhaust process of the vacuum adiabatic body, the time Δt3 may be a time t3a or more and a time t3b or less. The time t3a may be greater than or equal to about 0.2 hr and less than or equal to about 0.8 hr. The time t3b may be greater than or equal to about 1 hr and less than or equal to about 65.0 hr. Preferably, the time Δt3 may be about 0.2 hr or more and about 48.0 hr or less. Preferably, The time Δt3 may be about 0.3 hr or more and about 24.0 hr or less. More preferably, the time Δt3 may be about 0.4 hr or more and about 12.0 hr or less. More preferably, the time Δt3 may be about 0.5 hr or more and about 5.0 hr or less. After the heating and/or drying process is performed during the exhaust process, the cooling process may be performed. For example, when the heating and/or drying process is performed for a long time, the time Δt3 may be long. The vacuum adiabatic body according to the present disclosure may be manufactured so that the time Δt1 is greater than the time Δt2, the time Δt1 is less than or equal to the time Δt3, and/or the time Δt3 is greater than the time Δt2. Preferably, the following relational expression is satisfied: Δt2<Δt1≤Δt3.

The vacuum adiabatic body according to an embodiment may be manufactured so that the relational expression: Δt1+Δt2+Δt3 may be greater than or equal to about 0.3 hr and less than or equal to about 70 hr, be greater than or equal to about 1 hr and less than or equal to about 65 hr, or be greater than or equal to about 2 hr and less than or equal to about 24 hr. Preferably, the relational expression: Δt1+Δt2+Δt3 may be manufactured to be greater than or equal to about 3 hr and less than or equal to about 6 hr.

An example of the vacuum pressure condition during the exhaust process is as follows. The present disclosure may be any one of the following examples or a combination of two or more examples. A minimum value of the vacuum pressure in the vacuum space during the exhaust process may be greater than about 1.8E-6 Torr. Preferably, the minimum value of the vacuum pressure may be greater than about 1.8E-6 Torr and less than or equal to about 1.0E-4 Torr, be greater than about 0.5E-6 Torr and less than or equal to about 1.0E-4 Torr, or be greater than about 0.5E-6 Torr and less than or equal to about 0.5E-5 Torr. More preferably, the minimum value of the vacuum pressure may be greater than about 0.5E-6 Torr and less than about 1.0E-5 Torr. As such, the limitation in which the minimum value of the vacuum pressure provided during the exhaust process is because, even if the pressure is reduced through the vacuum pump during the exhaust process, the degree of the decrease of vacuum pressure is slowed below a certain level. As an embodiment, after the exhaust process is performed, the vacuum pressure of the vacuum space may be maintained at a pressure greater than or equal to about 1.0E-5 Torr and less than or equal to about 5.0E-1 Torr. The maintained vacuum pressure may be greater than or equal to about 1.0E-5 Torr and less than or equal to about 1.0E-1 Torr, be greater than or equal to about 1.0E-5 Torr and less than or equal to about 1.0E-2 Torr, be greater than or equal to about 1.0E-4 Torr and less than or equal to about 1.0E-2 Torr, be greater than or equal to about 1.0E-5 Torr, and/or less than or equal to about 1.0E-3 Torr. As a result of predicting the change in vacuum pressure with an accelerated experiment of two example products, one product may be provided so that the vacuum pressure is maintained below about 1.0E-04 Torr even after about 16.3 years, and the other product may be provided so that the vacuum pressure is maintained below about 1.0E-04 Torr even after about 17.8 years. As described above, the vacuum pressure of the vacuum adiabatic body may be used industrially only when it is maintained below a predetermined level even if there is a change over time or aged deterioration.

FIG. 5a is a graph of an elapsing time and pressure in the exhaust process according to an example, and FIG. 5b is a view explaining results of a vacuum maintenance test in the acceleration experiment of the vacuum adiabatic body of the refrigerator having an internal volume of about 128 liters. Referring to FIG. 5b, it is seen that the vacuum pressure gradually increases according to the aging. For example, it is confirmed that the vacuum pressure is about 6.7E-04 Torr after about 4.7 years, about 1.7E-03 Torr after about 10 years, and about 1.0E-02 Torr after about 59 years. According to these experimental results, it is confirmed that the vacuum adiabatic body according to the embodiment is sufficiently industrially applicable.

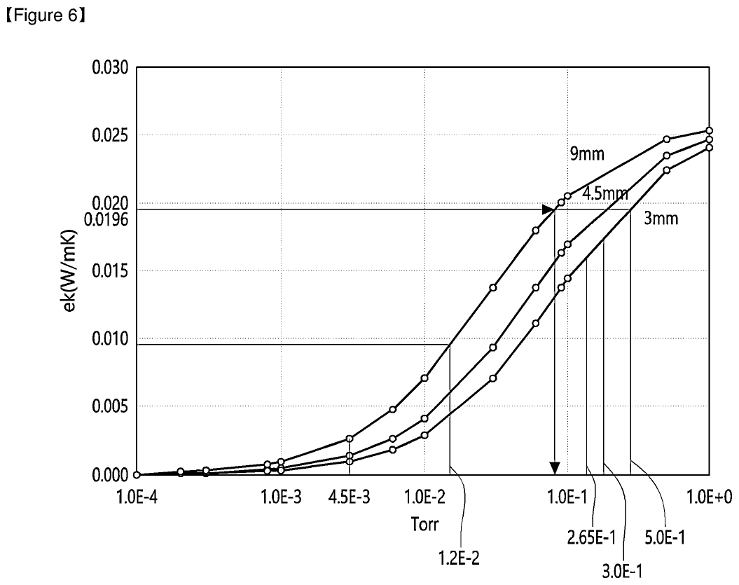

FIG. 6 is a graph illustrating results obtained by comparing the vacuum pressure with gas conductivity. Referring to FIG. 6, gas conductivity with respect to the vacuum pressure depending on a size of the gap in the vacuum space 50 was represented as a graph of effective heat transfer coefficient (ek). The effective heat transfer coefficient (eK) was measured when the gap in the vacuum space 50 has three values of about 3 mm, about 4.5 mm, and about 9 mm. The gap in the vacuum space 50 is defined as follows. When the radiation resistance sheet 32 exists inside the vacuum space 50, the gap may be a distance between the radiation resistance sheet 32 and the plate adjacent thereto. When the radiation resistance sheet 32 does not exist inside the vacuum space 50, the gap may be a distance between the first and second plates. It was seen that, since the size of the gap is small at a point corresponding to a typical effective heat transfer coefficient of about 0.0196 W/mK, which is provided to an adiabatic material formed by foaming polyurethane, the vacuum pressure is about 5.0E-1 Torr even when the size of the gap is about 3 mm. Meanwhile, it was seen that the point at which reduction in adiabatic effect caused by the gas conduction heat is saturated, even though the vacuum pressure decreases, is a point at which the vacuum pressure is approximately 4.5E-3 Torr. The vacuum pressure of about 4.5E-3 Torr may be defined as the point at which the reduction in adiabatic effect caused by the gas conduction heat is saturated. Also, when the effective heat transfer coefficient is about 0.01 W/mK, the vacuum pressure is about 1.2E-2 Torr. An example of a range of the vacuum pressure in the vacuum space according to the gap is presented. The support may include at least one of a bar, a connection plate, or a support plate. In this case, when the gap of the vacuum space is greater than or equal to about 3 mm, the vacuum pressure may be greater than or equal to A and less than about 5E-1 Torr, or be greater than about 2.65E-1 Torr and less than about 5E-1 Torr. As another example, the support may include at least one of a bar, a connection plate, or a support plate. In this case, when the gap of the vacuum space is greater than or equal to about 4.5 mm, the vacuum pressure may be greater than or equal to A and less than about 3E-1 Torr, or be greater than about 1.2E-2 Torr and less than about 5E-1 Torr. As another example, the support may include at least one of a bar, a connection plate, or a support plate, and when the gap of the vacuum space is greater than or equal to about 9 mm, the vacuum pressure may be greater than or equal to A and less than about 1.0E-1 Torr, or be greater than about 4.5E-3 Torr and less than about 5E-1 Torr. Here, the A may be greater than or equal to about 1.0E-6 Torr and less than or equal to about 1.0E-5 Torr. The A may be greater than or equal to about 1.0-5 Torr and less than or equal to about 1.0E-4 Torr. When the support includes a porous material or a filler, the vacuum pressure may be greater than or equal to about 4.7E-2 Torr and less than or equal to about 5E-1 Torr. In this case, it is understood that the size of the gap ranges from several micrometers to several hundreds of micrometers. When the support and the porous material are provided together in the vacuum space, a vacuum pressure may be created and used, which is middle between the vacuum pressure when only the support is used and the vacuum pressure when only the porous material is used.

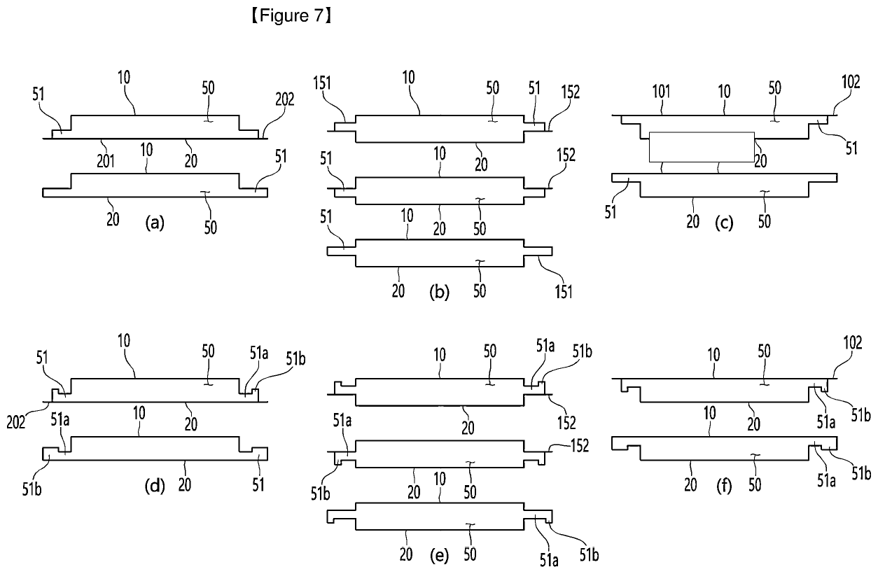

FIG. 7 is a view illustrating various examples of the vacuum space. The present disclosure may be any one of the following examples or a combination of two or more examples.

Referring to FIG. 7, the vacuum adiabatic body according to the present disclosure may include a vacuum space. The vacuum space 50 may include a first vacuum space extending in a first direction (e.g., X-axis) and having a predetermined height. The vacuum space 50 may optionally include a second vacuum space (hereinafter, referred to as a vacuum space expansion portion) different from the first vacuum space in at least one of the height or the direction. The vacuum space expansion portion may be provided by allowing at least one of the first and second plates or the side plate to extend. In this case, the heat transfer resistance may increase by lengthening a heat conduction path along the plate. The vacuum space expansion portion in which the second plate extends may reinforce adiabatic performance of a front portion of the vacuum adiabatic body. The vacuum space expansion portion in which the second plate extends may reinforce adiabatic performance of a rear portion of the vacuum adiabatic body, and the vacuum space expansion portion in which the side plate extends may reinforce adiabatic performance of a side portion of the vacuum adiabatic body. Referring to FIG. 7a, the second plate may extend to provide the vacuum space expansion portion 51. The second plate may include a second portion 202 extending from a first portion 201 defining the vacuum space 50 and the vacuum space expansion portion 51. The second portion 202 of the second plate may branch a heat conduction path along the second plate to increase in heat transfer resistance. Referring to FIG. 7b, the side plate may extend to provide the vacuum space expansion portion. The side plate may include a second portion 152 extending from a first portion 151 defining the vacuum space 50 and the vacuum space extension portion 51. The second portion of the side plate may branch the heat conduction path along the side plate to improve the adiabatic performance. The first and second portions 151 and 152 of the side plate may branch the heat conduction path to increase in heat transfer resistance. Referring to FIG. 7c, the first plate may extend to provide the vacuum space expansion portion. The first plate may include a second portion 102 extending from the first portion 101 defining the vacuum space 50 and the vacuum space expansion portion 51. The second portion of the first plate may branch the heat conduction path along the second plate to increase in heat transfer resistance. Referring to FIG. 7d, the vacuum space expansion portion 51 may include an X-direction expansion portion 51a and a Y-direction expansion portion 51b of the vacuum space. The vacuum space expansion portion 51 may extend in a plurality of directions of the vacuum space 50. Thus, the adiabatic performance may be reinforced in multiple directions and may increase by lengthening the heat conduction path in the plurality of directions to improve the heat transfer resistance. The vacuum space expansion portion extending in the plurality of directions may further improve the adiabatic performance by branching the heat conduction path. Referring to FIG. 7e, the side plate may provide the vacuum space extension portion extending in the plurality of directions. The vacuum space expansion portion may reinforce the adiabatic performance of the side portion of the vacuum adiabatic body. Referring to FIG. 7f, the first plate may provide the vacuum space extension portion extending in the plurality of directions. The vacuum space expansion portion may reinforce the adiabatic performance of the side portion of the vacuum adiabatic body.

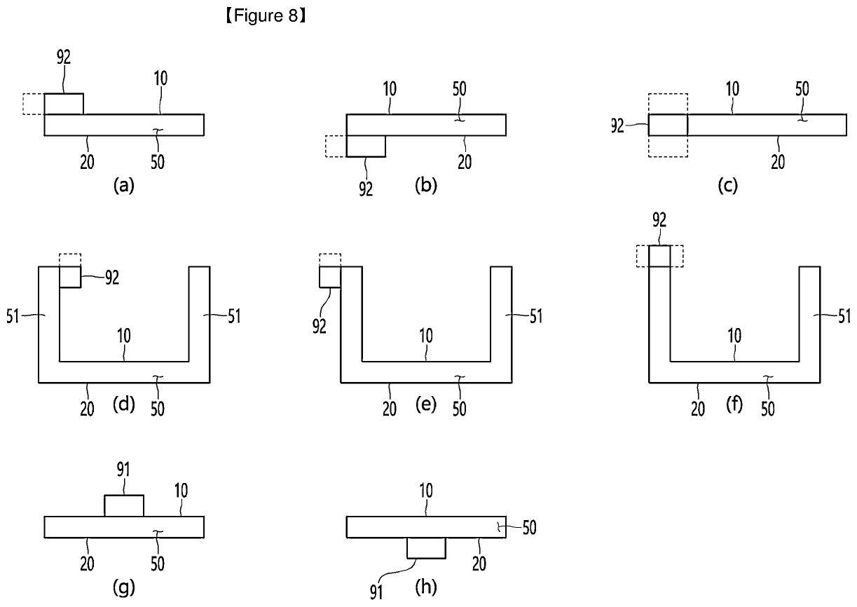

FIG. 8 is a view for explaining another adiabatic body. The present disclosure may be any one of the following examples or a combination of two or more examples. Referring to FIG. 8, the vacuum adiabatic body according to the present disclosure may optionally include another adiabatic body 90. Another adiabatic body may have a degree of vacuum less than that of the vacuum adiabatic body and be an object that does not include a portion having a vacuum state therein. Referring to FIGS. 8a to 8f, another adiabatic body may include a peripheral adiabatic body. The peripheral adiabatic body may be disposed on at least a portion of a peripheral portion of the vacuum adiabatic body, a peripheral portion of the first plate, a peripheral portion of the second plate, and the side plate. The peripheral adiabatic body disposed on the peripheral portion of the first plate or the peripheral portion of the second plate may extend to a portion at which the side plate is disposed or may extend to the outside of the side plate. The peripheral adiabatic body disposed on the side plate may extend to a portion at which the first plate or may extend to the outside of the first plate or the second plate. Referring to FIGS. 8g to 8h, another adiabatic body may include a central adiabatic body. The central adiabatic body may be disposed on at least a portion of a central portion of the vacuum adiabatic body, a central portion of the first plate, or a central portion of the second plate.

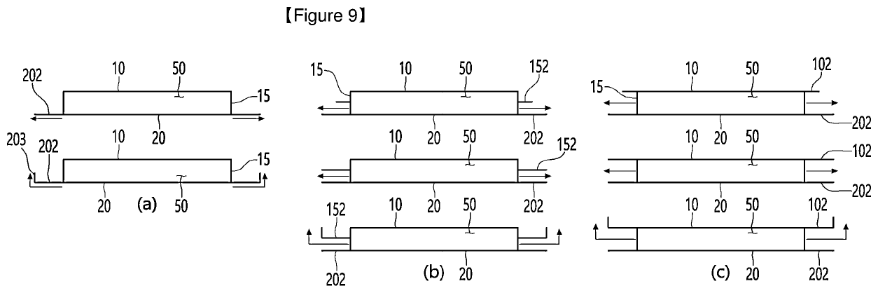

FIG. 9 is a view for explaining a heat transfer path between first and second plates having different temperatures. An example of the heat transfer path is as follows. The present disclosure may be any one of the following examples or a combination of two or more examples.

The heat transfer path may pass through the extension portion at at least a portion of the first portion 101 of the first plate, the first portion 201 of the second plate, or the first portion 151 of the side plate. The first portion may include a portion defining the vacuum space. The extension portions 102, 152, and 202 may include portions extending in a direction away from the first portion. The extension portion may include a side portion of the vacuum adiabatic body, a side portion of the plate having a higher temperature among the first and second plates, or a portion extending toward the side portion of the vacuum space 50. The extension portion may include a front portion of the vacuum adiabatic body, a front portion of the plate having a higher temperature among the first and second plates, or a front portion extending in a direction away from the front portion of the vacuum space 50. Through this, it is possible to reduce generation of dew on the front portion. The vacuum adiabatic body or the vacuum space 50 may include first and second surfaces having different temperatures from each other. The temperature of the first surface may be lower than that of the second surface. For example, the first surface may be the first plate, and the second surface may be the second plate. The extension portion may extend in a direction away from the second surface or include a portion extending toward the first surface. The extension portion may include a portion, which is in contact with the second surface, or a portion extending in a state of being in contact with the second surface. The extension portion may include a portion extending to be spaced apart from the two surfaces. The extension portion may include a portion having heat transfer resistance greater than that of at least a portion of the plate or the first surface. The extension portion may include a plurality of portions extending in different directions. For example, the extension portion may include a second portion 202 of the second plate and a third portion 203 of the second plate. The third portion may also be provided on the first plate or the side plate. Through this, it is possible to increase in heat transfer resistance by lengthening the heat transfer path. In the extension portion, the above-described heat transfer resistor may be disposed. Another adiabatic body may be disposed outside the extending portion. Through this, the extension portion may reduce generation of dew on the second surface. Referring to FIG. 9a, the second plate may include the extension portion extending to the peripheral portion of the second plate. Here, the extension portion may further include a portion extending backward. Referring to FIG. 9b, the side plate may include the extension portion extending to a peripheral portion of the side plate. Here, the extension portion may be provided to have a length that is less than or equal to that of the extension portion of the second plate. Here, the extension portion may further include a portion extending backward. Referring to FIG. 9c, the first plate may include the extension portion extending to the peripheral portion of the first plate. Here, the extension portion may extend to a length that is less than or equal to that of the extension portion of the second plate. Here, the extension portion may further include a portion extending backward.

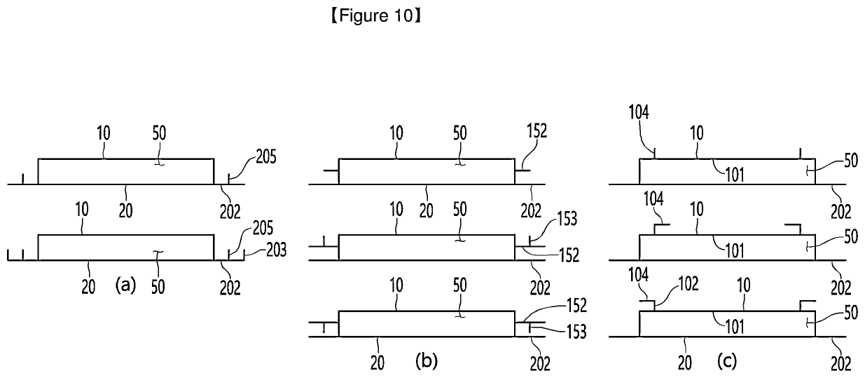

FIG. 10 is a view for explaining a branch portion on the heat transfer path between first and second plates having different temperatures. An example of the branch portion is as follows. The present disclosure may be any one of the following examples or a combination of two or more examples.

Optionally, the heat transfer path may pass through portions 205, 153, and 104, each of which is branched from at least a portion of the first plate, the second plate, or the side plate. Here, the branched heat transfer path means a heat transfer path through which heat flows to be separated in a different direction from the heat transfer path through which heat flows along the plate. The branched portion may be disposed in a direction away from the vacuum space 50. The branched portion may be disposed in a direction toward the inside of the vacuum space 50. The branched portion may perform the same function as the extension portion described with reference to FIG. 9, and thus, a description of the same portion will be omitted. Referring to FIG. 10a, the second plate may include the branched portion 205. The branched portion may be provided in plurality, which are spaced apart from each other. The branched portion may include a third portion 203 of the second plate. Referring to FIG. 10b, the side plate may include the branched portion 153. The branched portion 153 may be branched from the second portion 152 of the side plate. The branched portion 153 may provide at least two. At least two branched portions 153 spaced apart from each other may be provided on the second portion 152 of the side plate. Referring to FIG. 10c, the first plate may include the branched portion 104. The branched portion may further extend from the second portion 102 of the first plate. The branched portion may extend toward the peripheral portion. The branched portion 104 may be bent to further extend. A direction in which the branched portion extends in FIGS. 10a, 10b, and 10c may be the same as at least one of the extension directions of the extension portion described in FIG. 10.

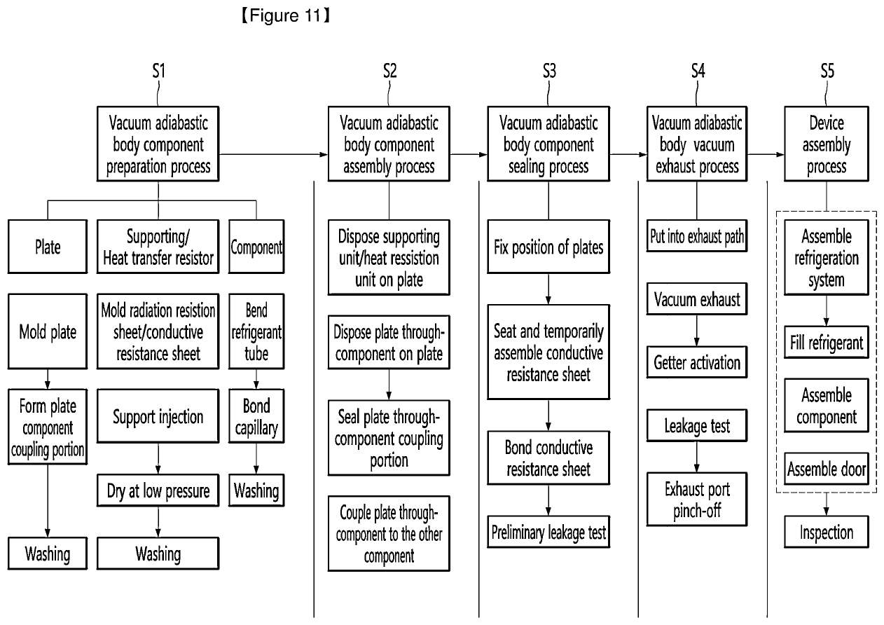

FIG. 11 is a view for explaining a process of manufacturing the vacuum adiabatic body.

Optionally, the vacuum adiabatic body may be manufactured by a vacuum adiabatic body component preparation process in which the first plate and the second plate are prepared in advance. Optionally, the vacuum adiabatic body may be manufactured by a vacuum adiabatic body component assembly process in which the first plate and the second plate are assembled. Optionally, the vacuum adiabatic body may be manufactured by a vacuum adiabatic body vacuum exhaust process in which a gas in the space defined between the first plate and the second plate is discharged. Optionally, after the vacuum adiabatic body component preparation process is performed, the vacuum adiabatic body component assembly process or the vacuum adiabatic body exhaust process may be performed. Optionally, after the vacuum adiabatic body component assembly process is performed, the vacuum adiabatic body vacuum exhaust process may be performed. Optionally, the vacuum adiabatic body may be manufactured by the vacuum adiabatic body component sealing process (S3) in which the space between the first plate and the second plate is sealed. The vacuum adiabatic body component sealing process may be performed before the vacuum adiabatic body vacuum exhaust process (S4). The vacuum adiabatic body may be manufactured as an object with a specific purpose by an apparatus assembly process (S5) in which the vacuum adiabatic body is combined with the components constituting the apparatus. The apparatus assembly process may be performed after the vacuum adiabatic body vacuum exhaust process. Here, the components constituting the apparatus means components constituting the apparatus together with the vacuum adiabatic body.

The vacuum adiabatic body component preparation process (S1) is a process in which components constituting the vacuum adiabatic body are prepared or manufactured. An example of a vacuum adiabatic body vacuum exhaust process vacuum is as follows. The present disclosure may be any one of the, examples or a combination of two or more examples. The vacuum adiabatic body vacuum exhaust process may include at least one of a process of inputting the vacuum adiabatic body into an exhaust passage, a getter activation process, a process of checking vacuum leakage and a process of closing the exhaust port. The process of forming the coupling part may be performed in at least one of the vacuum adiabatic body component preparation process, the vacuum adiabatic body component assembly process, or the apparatus assembly process. Before the vacuum adiabatic body exhaust process is performed, a process of washing the components constituting the vacuum adiabatic body may be performed. Optionally, the washing process may include a process of applying ultrasonic waves to the components constituting the vacuum adiabatic body or a process of providing ethanol or a material containing ethanol to surfaces of the components constituting the vacuum adiabatic body. The ultrasonic wave may have an intensity between about 10 kHz and about 50 kHz. A content of ethanol in the material may be about 50% or more. For example, the content of ethanol in the material may range of about 50% to about 90%. As another example, the content of ethanol in the material may range of about 60% to about 80%. As another example, the content of ethanol in the material may be range of about 65% to about 75%. Optionally, after the washing process is performed, a process of drying the components constituting the vacuum adiabatic body may be performed. Optionally, after the washing process is performed, a process of heating the components constituting the vacuum adiabatic body may be performed.

The contents described in FIGS. 1 to 11 may be applied to all or selectively applied to the embodiments described with reference to the drawings below.

As an embodiment, an example of a process associated with a plate is as follows. Any one or two or more examples among following examples of the present disclosure will be described. The vacuum adiabatic body component preparation process may include a process of manufacturing the plate. Before the vacuum adiabatic body vacuum exhaust process is performed, the process of manufacturing the plate may be performed. Optionally, the plate may be manufactured by a metal sheet. For example, a thin and wide plate may be manufactured using plastic deformation. Optionally, the manufacturing process may include a process of molding the plate. The molding process may be applied to the molding of the side plate or may be applied to a process of integrally manufacturing at least a portion of at least one of the first plate and the second plate, and the side plate. For example, the molding may include drawing. The molding process may include a process in which the plate is partially seated on a support. The molding process may include a process of partially applying force to the plate. The molding process may include a process of seating a portion of the plate on the support a process of applying force to the other portion of the plate. The molding process may include a process of deforming the plate. The deforming process may include a process of forming at least one or more curved portions on the plate. The deforming process may include a process of changing a curvature radius of the plate or a process of changing a thickness of the plate. As a first example, the process of changing the thickness may include a process of allowing a portion of the plate to increase in thickness, and the portion may include a portion extending in a longitudinal direction of the internal space (a first straight portion). The portion may be provided in the vicinity of the portion at which the plate is seated on the support in the process of molding the plate. As a second example, the process of changing the thickness may include a process of reducing a thickness of a portion of the plate, and the portion may include a portion extending in a longitudinal direction of the internal space (a second straight portion). The portion may be provided in the vicinity of a portion to which force is applied to the plate in the process of molding the plate. As a third example, the process of changing the thickness may include a process of reducing a thickness of a portion of the plate, and the portion may include a portion extending in a height direction of the internal space (the second straight portion). The portion may be connected to the portion extending in the longitudinal direction of the internal space of the plate. As a fourth example, the process of changing the thickness may include a process of allowing a portion of the plate to increase in thickness, and the portion may include at least one of a portion to which the side plate extends in the longitudinal direction of the internal space and a curved portion provided between the portions extending in the height direction of the internal space (a first curved portion). The curved portion may be provided at the portion seated on the support of the plate or in the vicinity of the portion in the process of molding the plate. As a fifth example, the process of changing the thickness may include a process of allowing a portion of the plate to decrease in thickness, and the portion may include at least one of a portion to which the side plate extends in the longitudinal direction of the internal space and a curved portion provided between the portions extending in the height direction of the internal space (a second curved portion). The curved portion may be provided in the vicinity of a portion to which force is applied to the plate in the process of molding the plate. The deforming process may be any one of the above-described examples or an example in which at least two of the above-described examples are combined.

The process associated with the plate may selectively include a process of washing the plate. An example of a process sequence associated with the process of washing the plate is as follows. The present disclosure may be any one of the following examples or a combination of two or more examples. Before the vacuum adiabatic body vacuum exhaust process is performed, the process of washing the plate may be performed. After the process of manufacturing the plate is performed, at least one of the process of molding the plate and the process of washing the plate may be performed. After the process of molding the plate is performed, the process of washing the plate may be performed. Before the process of molding the plate is performed, the process of washing the plate may be performed. After the process of manufacturing the plate is performed, at least one of a process of providing a component coupling portion to a portion of the plate or the process of washing the plate may be performed. After the process of providing the component coupling portion to a portion of the plate is performed, the process of washing the plate may be performed.

The process associated with the plate selectively include the process of providing the component coupling portion to the plate. An example of a process sequence associated with the process of providing the component coupling portion to the plate is as follows. The present disclosure may be any one of the following examples or a combination of two or more examples. Before the vacuum adiabatic body vacuum exhaust process is performed, a process of providing the component coupling portion to a portion of the plate may be performed. For example, the process of providing the component coupling portion may include a process of manufacturing a tube provided to the component coupling portion. The tube may be connected to a portion of the plate. The tube may be disposed in an empty space provided in the plate or in an empty space provided between the plates. As another example, the process of providing the component coupling portion may include a process of providing a through-hole in a portion of the plate. For another example, the process of providing the component coupling portion may include a process of providing a curved portion to at least one of the plate or the tube.

The process associated with the plate may optionally include a process for sealing the vacuum adiabatic body component associated with the plate. An example of a process sequence associated with the process of sealing the vacuum adiabatic body component associated with the plate is as follows. The present disclosure may be any one of the following examples or a combination of two or more examples. After the process of providing the through-hole in the portion of the plate is performed, at least one of a process of providing a curved portion to at least a portion of the plate or the tube or a process of providing a seal between the plate and the tube may be performed. After the process of providing the curved portion to at least a portion of at least one of the plate or the tube is performed, the process of sealing the gap between the plate and the tube may be performed. The process of providing the through-hole in the portion of the plate and the process of providing the curved portion in at least a portion of the plate and the tube may be performed at the same time. The process of providing a through-hole in a part of the plate and the process of providing the seal between the plate and the tube may be performed at the same time. After the process of providing the curved portion to the tube is performed, the process of providing a through-hole in the portion of the plate may be performed. Before the vacuum adiabatic body vacuum exhaust process is performed, a portion of the tube may be provided and/or sealed to the plate, and after the vacuum adiabatic body vacuum exhaust process is performed, the other portion of the tube may be sealed.

When at least a portion of the plate is used to be integrated with a heat transfer resistor, the example of the process associated with the plate may also be applied to the example of the process of the heat transfer resistor.

Optionally, the vacuum adiabatic body may include a side plate connecting the first plate to the second plate. Examples of the side plate are as follows. The present disclosure may be any one of the following examples or a combination of two or more examples. The side plate may be provided to be integrated with at least one of the first or second plate. The side plate may be provided to be integrated with any one of the first and second plates. The side plate may be provided as any one of the first and second plates. The side plate may be provided as a portion of any one of the first and second plates. The side plate may be provided as a component separated from the other of the first and second plates. In this case, optionally, the side plate may be provided to be coupled or sealed to the other one of the first and second plates. The side plate may include a portion having a degree of strain resistance, which is greater than that of at least a portion of the other one of the first and second plates. The side plate may include a portion having a thickness greater than that of at least a portion of the other one of the first and second plates. The side plate may include a portion having a curvature radius less than that of at least a portion of the other one of the first and second plates.

In a similar example to this, optionally, the vacuum adiabatic body may include a heat transfer resistor provided to reduce a heat transfer amount between a first space provided in the vicinity of the first plate and a second space provided in the vicinity of the second plate. Examples of the heat transfer resistor are as follows. The present disclosure may be any one of the following examples or a combination of two or more examples. The heat transfer resistor may be provided to be integrated with at least one of the first or second plate. The heat transfer resistor may be provided to be integrated with any one of the first and second plates. The heat transfer resistor may be provided as any one of the first and second plates. The heat transfer resistor may be provided as a portion of any one of the first and second plates. The heat transfer resistor may be provided as a component separated from the other one of the first and second plates. In this case, optionally, the heat transfer resistor may be provided to be coupled or sealed to the other one of the first and second plates. The heat transfer resistor may include a portion having a degree of heat transfer resistance, which is greater than that of at least a portion of the other one of the first and second plates. The heat transfer resistor may include a portion having a thickness less than that of at least a portion of the other one of the first and second plates. The heat transfer resistor may include a portion having a curvature radius less than that of at least a portion of the other one of the first and second plates. The heat transfer resistor may include a portion having a curvature radius less than that of at least a portion of the other one of the first and second plates.

The contents described in FIGS. 1 to 11 may be applied to all or selectively applied to the embodiments described with reference to the drawings below.

The installation of the tube will be schematically described.

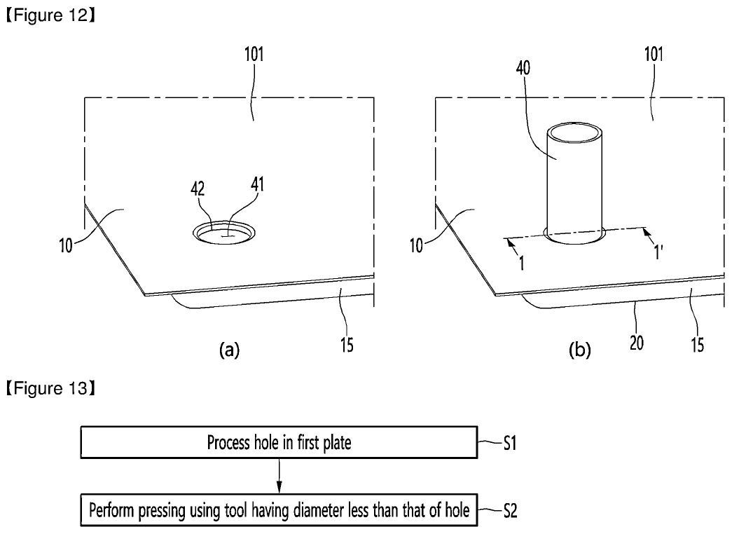

FIG. 12 is a perspective view in which a tube is installed in a vacuum adiabatic body. Here, (a) of FIG. 12 is a view illustrating a state before the tube is coupled, and (b) of FIG. 12 is a view illustrating a state after the tube is coupled.

Referring to FIG. 12, the vacuum adiabatic body according to one or more embodiments may have a tube 40. The tube 40 may be a tube for exhausting a fluid of the vacuum space 50. The tube 40 may be a tube for a getter, in which a getter for gas adsorption is supported. The tube 40 may serve as an exhaust port and a getter port.

Optionally, a thickness of the tube may be greater than that of the first plate 10. The thickness of the tube may be provided to be thicker than that of the second plate 20. The thickness of the tube may be provided to a thickness that is sufficient to withstand compression required for sealing the tube. The sealing may be performed through pinch-off. The tube may have a sufficient wall thickness.

Optionally, the tube may be provided as a circular or oval hollow tube made of a metal. The tube may be sealed after the exhaust or after inserting the getter. The tube may be sealed through pressure welding. The tube may be sealed by deforming the tube. The tube may be sealed through pinching-off. The tube may be made of copper (CU) for easy deformation. Copper having strength less than that of stainless steel may be used as the tube. Since the easily deformable copper is used, the pinch-off process may be smoothly performed. In addition, it is possible to reliably provide the seal. Optionally, the flange 42 may have a predetermined height portion HL extending in a height direction of the vacuum space. The curvature portion may guide the tube 40. The curvature portion may allow the tube to be conveniently inserted into the through-hole 41. Examples of the aforementioned tube may be ports such as an exhaust port or a getter port.

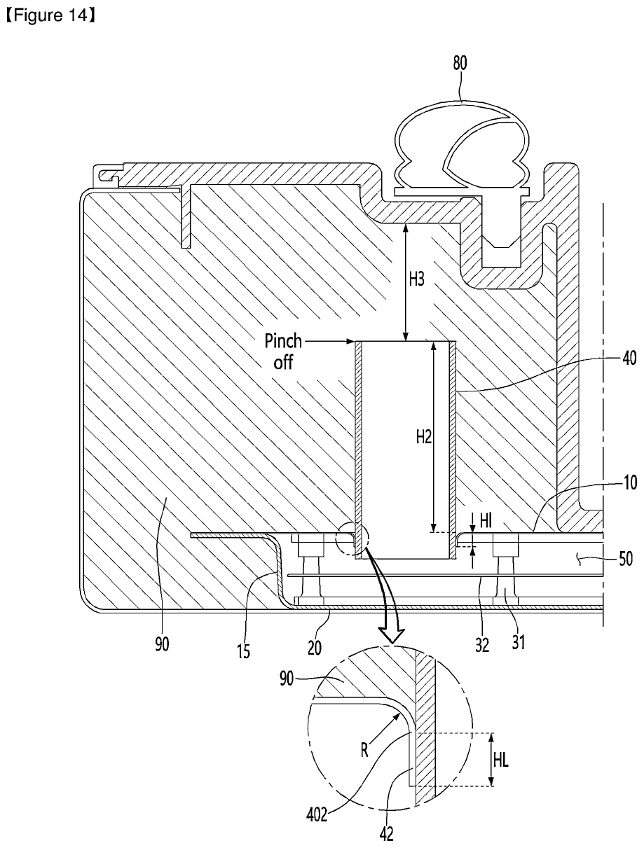

FIG. 13 is a view for explaining a method of processing the through-hole of the first plate.

Referring to FIG. 13, a hole may be processed in the first plate 10 (S1). Thereafter, the hole may be pressed using a pressing tool having a diameter greater than that of the hole (S2).

Optionally, to smoothly form the flange 42 in the burring process, the following method may be applied. It may provide small force compared to the force applied in the general burring process. The force may be applied gradually for a longer time than that required for the general burring process. A first curvature may be processed in the peripheral portion of the hole provided by the piercing process between the piercing process and the burring process. During the burring process, a support having a groove corresponding to a desired shape of the burr may be provided on a surface on which the burr is generated. It may provide the flange 42 having a small curvature radius R through the above process. A portion at which the curvature radius is formed may be referred to as a curvature portion. Examples of the aforementioned tube may be ports such as an exhaust port or a getter port.

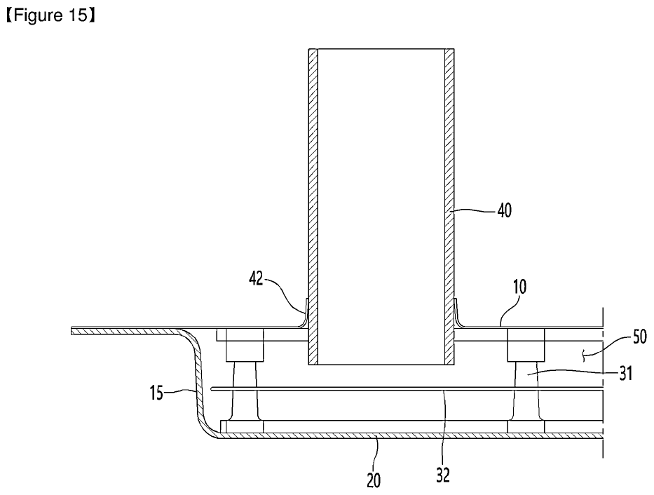

FIG. 14 is a cross-sectional view taken along line 1-1′ of FIG. 12b. For reference, FIG. 14 illustrates a state in which the vacuum adiabatic body is applied to a door. A cross-section of the tube and its related configuration will be described with reference to FIG. 14.

In one or more embodiments, the first plate 10 may have a thickness of at least about 0.1 mm or more. Thus, it may secure rigidity to obtain process stability when inserting the tube 40. The thickness of the first plate 10 may be about 0.1 mm. The second plate 20 may have a thickness of about 0.5 mm or more. The thin first plate 10 may be provided because conductive heat decreases. If the first plate 10 is thin, there may be a disadvantage that it is vulnerable to deformation. When the tube 40 is inserted into the through-hole 41, the first plate 10 in the vicinity of the through-hole 41 may be deformed. Optionally, A height H1 of the flange 42 may be provided to be about 1 mm or more and about 3 mm or less. When the height of the flange 42 exceeds about 3 mm, there is a high risk that the heat transfer resistor 32 and the flange 42 are in contact with each other. Optionally, the curvature radius R of the curvature portion of the flange 42 defining the through-hole 41 may be less than that of each of all bent portions provided on the first plate 10. The curvature radius R of the flange 42 defining the through-hole 41 may be less than that of each of all bent portions provided on the second plate 20. Optionally, the tube may be insulated with the additional adiabatic body 90. The additional adiabatic body 90 may insulate a gap between the tube 40 and the first space and/or a gap between the tube 40 and the second space. Examples of the aforementioned tube may be ports such as an exhaust port or a getter port.

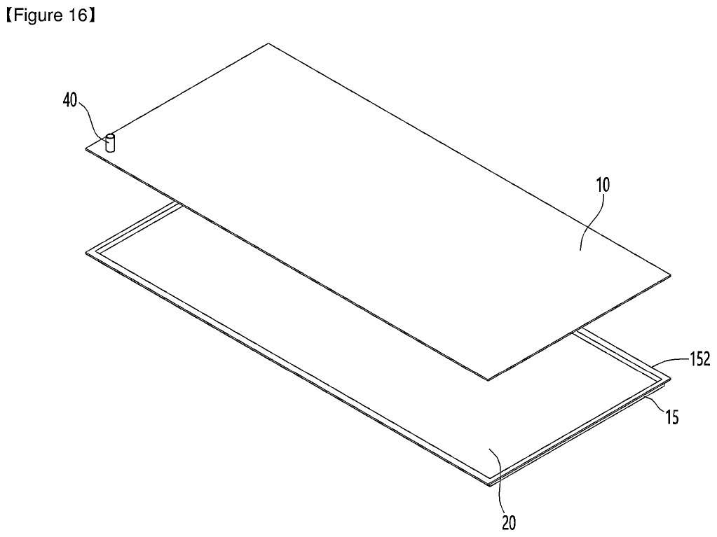

FIG. 15 illustrates an example in which a flange extends toward the outside of the vacuum space. other structure and function are same with the another one or more embodiments.

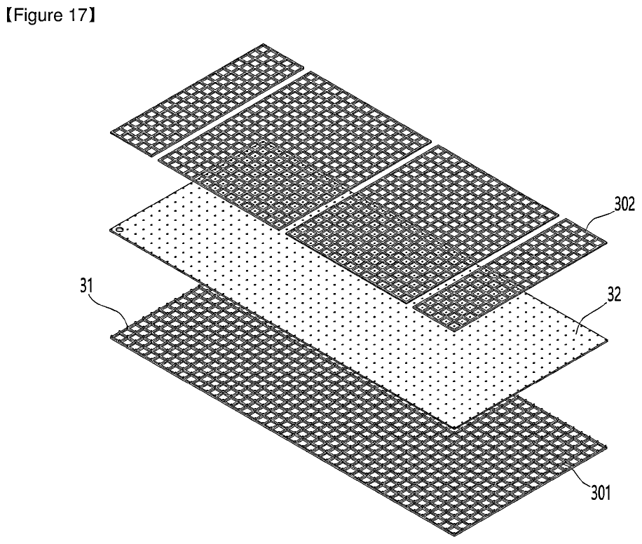

FIGS. 16 to 18 are views for explaining a method for manufacturing a vacuum adiabatic body.

Referring to FIG. 16, in one or more embodiments, the second plate 20 may be processed to form an accommodation space. The first plate 10 and the second plate 20 may be fastened to each other. The side plate 15 and the second plate 20 may be bent to each other to form the accommodation space. The side plate 15 and the second plate 20 may extend in different directions from each other.

Referring to FIG. 17, in one or more embodiments, at least one of the first support 301 and the second support 302 may provide a resin as a material. Through this, the thermal conductivity can be lowered. The outer panel and the inner panel may also provide a resin as a material in order to lower the thermal conductivity.

Optionally, at least one of the first support 301 and the second support 302 may be provided as at least two spaced apart components. The figure illustrates that the second support 302 is made of components that are spaced apart from each other. Each component of the first support 301 and each component of the second support 302 may be alternately connected to each other. A component of the second support 302 may be placed between two components of the first support 301 that are spaced apart from each other.

Optionally, a heat transfer resistor 32 may be placed in the middle of the first and second supports 30. The position of the heat transfer resistor 32 may be fixed by fastening the first and second supports 301 and 302. In the vacuum adiabatic body component assembling step S2, the support 30, the heat transfer resistor, and the through-component may be assembled to the plate. Here, the heat transfer resistor may include the radiation resistance sheet 32. The heat transfer resistor may include other components.

Referring to FIG. 18, optionally, after the first and second supports 301 and 302 and the heat transfer resistor are fastened, the assembly of the support 30 and the heat transfer resistor 32 may be placed in the accommodation space. After the assembly is placed in the accommodation space, the first plate 10 may be placed on the second plate 20. The second plate 20 and the first plate 10 may be sealed with each other in the second portion 152 of the side plate. For sealing, sealing may be performed.

Optionally, in the vacuum adiabatic body component sealing step S3, the vacuum space 50 may be sealed with respect to the first space and the second space. The vacuum adiabatic body component sealing step S3 may be performed by sealing the first plate 10 and the second plate 20.

In one or more embodiments, the radiation resistance sheet may resist radiation heat transfer between the first and second plates. The reduction in the radiation heat transfer is independent of the thickness of the radiation resistance sheet. If the radiation resistance sheet is too thin, the problem with the radiation resistance sheet moving easily may occur. When the radiation resistance sheet moves, an unexpected noise may occur. The noise may be generated by a collision between the radiation resistance sheet and the peripheral member. In order to strongly support the radiation resistance sheet, the thickness of the radiation resistance sheet may be increased. As the thickness of the radiation resistance sheet increases, the support by contact with adjacent components may be strong. The radiation resistance sheet may strongly hold the support.

Optionally, the first and second plates may have a curvature. The radiation resistance sheet may not have a curvature. The radiation resistance sheet may be supported on the support without curvature. If the thickness of the radiation resistance sheet is thick, it may be difficult to process the curvature.

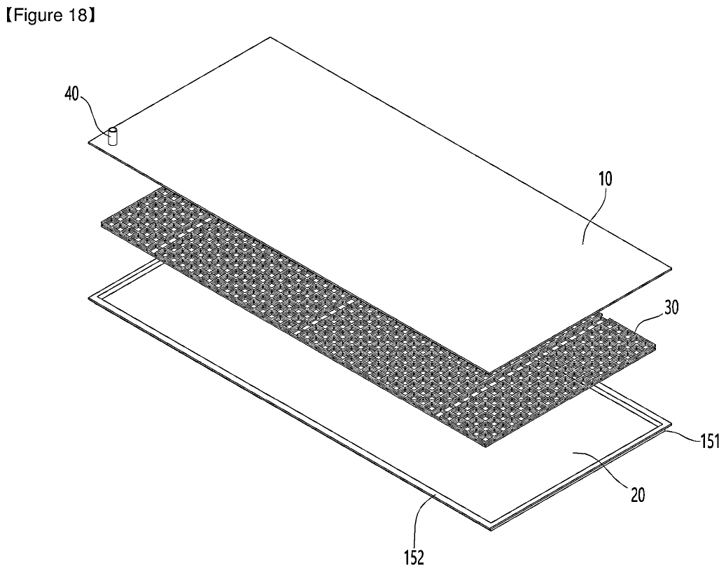

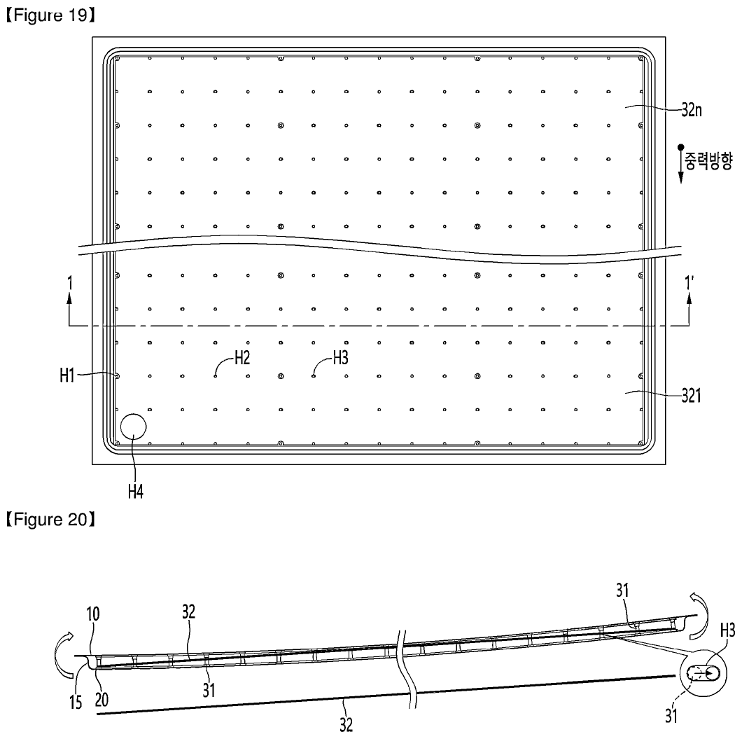

FIG. 19 is a plan view illustrating the vacuum adiabatic body of the embodiment, and FIG. 20 is a cross-sectional view taken along line 1-1′ of FIG. 19. Referring to FIGS. 19 and 20, optionally, the first and second plates 10 and 20 and the support 31 may have a predetermined curvature. The radiation resistance sheet 32 placed in the vacuum space 50 may be provided to be flat. In FIG. 20, in order to illustrate that the radiation resistance sheet 32 is flat, it is illustrated in a form outside the vacuum space. The radiation resistance sheet may be provided in which n (321 to 32n) components are separated from each other. n (321-32n) components may be arranged to provide the radiation resistance sheet. At least two of the radiation resistance sheets may be separated from each other in one direction. At least two of the radiation resistance sheets may be separated from each other in the direction of gravity (arrow direction in FIG. 19). A central portion of the radiation resistance sheet may be adjacent to the first plate. The central portion of the radiation resistance sheet may be moved smaller along the support in the vacuum adiabatic body component assembly step. A peripheral portion of the radiation resistance sheet may be far from the first plate. The peripheral portion of the radiation resistance sheet may move much more along the support in the vacuum adiabatic body component assembly step. The radiation resistance sheet may be thicker than the first plate. The radiation resistance sheet may be thinner than the second plate. The radiation resistance sheet may have the same thickness as the second plate.

Optionally, the radiation resistance sheet 32 may have a curvature of an engineering negligible level. In this case, the center of curvature of the radiation resistance sheet may be placed in the same direction as at least one of the first and second plates. In this case, the radius of curvature of the radiation resistance sheet may be greater than the radius of curvature of at least one of the first and second plates.

The radiation resistance sheet may be provided on at least a portion of the vacuum adiabatic body. The radiation resistance sheet may be provided in the vacuum space. The radiation resistance sheet may include a portion in which a degree of resistance to heat transfer by radiation is greater than at least a portion of the first plate and/or the second plate. The radiation resistance sheet may include a portion having a curvature. The radiation resistance sheet may include a portion having no curvature. At least a portion of the first plate and/or the second plate may have a curvature. A center of curvature of the portion having a curvature of the radiation resistance sheet may be placed in the same direction as a center of curvature of at least a portion of the first plate and the second plate. The radius of curvature of the portion having the curvature of the radiation resistance sheet may include a portion greater than the radius of curvature of at least a portion of the first plate and the second plate.

In one or more embodiments, at least one type of hole may be provided in the radiation resistance sheet. Three types of through-holes H1, H2, and H3 into which the bar 31 is inserted may be provided in the radiation resistance sheet. At least one of the three types of holes H1, H2, and H3 may be provided in plurality. One interference prevention hole H4 for preventing interference with the tube may be provided in the radiation resistance sheet. The hole may be provided in a predetermined shape and regularity. In the drawing, the hole may be highlighted.

The hole will be described in more detail. First, referring to FIG. 20, optionally, in response that a vacuum is applied to the vacuum space, bending stress may be generated in the second plate 20 by atmospheric pressure. The bending stress may cause both ends of the vacuum adiabatic body to be bent in an arrow direction. The plates 10 and 20 may thermally expand under the high-temperature conditions of the vacuum adiabatic body vacuum evacuation step. During thermal expansion of the plates, the second plate 20 may dominate compared to the first plate 10. This is because the second plate is thicker than the first plate. The extension of the second plate 20 may further bend both ends of the vacuum adiabatic body in the direction of the arrow. In order to prevent the support from being damaged when the vacuum adiabatic body is bent, a predetermined tolerance may be provided between the hole and the bar. The support is particularly prone to breakage at the end portions. The tolerance may be provided as 1.0 mm or more. The radiation resistance sheet may be made of aluminum. The support may be made of a resin, for example, PPS. The radiation resistance sheet may have a coefficient of thermal expansion of 0.000023 mm/degree Celsius. The support may have a coefficient of thermal expansion of 0.000010 mm/degree Celsius. According to this, when the radiation resistance sheet expands by 1.7 mm under high temperature conditions, the support may expand by 0.7 mm. A difference in thermal expansion coefficient between the radiation resistance sheet and the support may cause damage to the support. In order to prevent damage to the support, a predetermined tolerance may be required for the hole and the bar. The tolerance may be provided as 1.0 mm or more. The through-hole may be provided symmetrically with respect to the upper and lower center lines of the radiation resistance sheet.

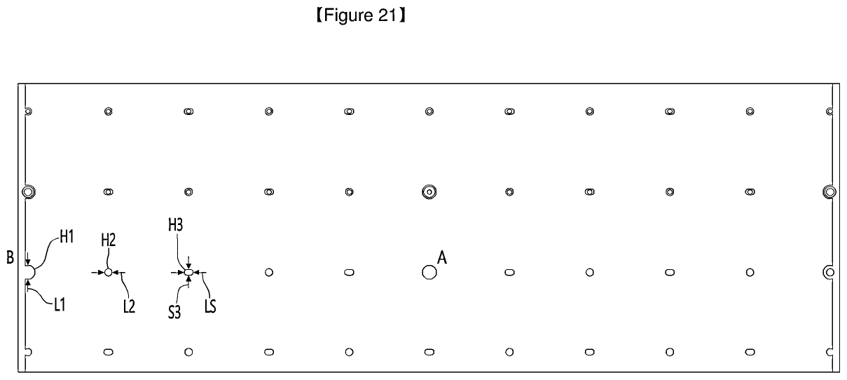

FIG. 21 is a view illustrating a state of observing an example of the radiation resistance sheet in a direction perpendicular to gravity. Throughout this document, descriptions of one embodiment may be applied to other embodiments. Referring to FIG. 21, a first hole H1 having the largest size, a second hole H2 having an intermediate size, and a third hole H3 having a smallest size are illustrated. Optionally, the size L1 of the first hole H1 may be greater than the size L2 of the second hole. The third hole H3 may have a major axis L3 and a minor axis S3. The minor axis S3 of the third hole may be the smallest among the holes of the radiation resistance sheet. A major axis L3 of the third hole may be larger than that of the second hole L2. The major axis L3 of the third hole may be provided in a curvature direction of the vacuum adiabatic body. The major axis L3 of the third hole may be provided in a direction perpendicular to gravity. A large-diameter portion of the bar may be inserted into the first hole H1. A small-diameter portion of the bar may be inserted into at least one of the second hole H2 and the third hole H3.

Optionally, the first hole H1 may be located at the center A and both ends B of the radiation resistance sheet in the left-right direction (for example, the direction perpendicular to gravity). Accordingly, the radiation resistance sheet can be inserted into the support in a flat state. At least one second hole and at least one third hole may be alternately placed between the center and one end of the radiation resistance sheet. At least one second hole and at least one third hole may be alternately placed in the vertical direction (for example, the gravity direction).

Optionally, the major axis L3 of the third hole may absorb the deformation of the vacuum adiabatic body due to atmospheric pressure and/or high exhaust temperature. There may be no curvature in the second plate in the vertical direction. Accordingly, the third hole may have a minor axis S3. The major axis L3 of the third hole can absorb the relative movement of the radiation resistance sheet and the support due to a difference in thermal expansion coefficient between the radiation resistance sheet and the support. Since the plurality (n) of radiation resistance sheets are separated from each other in the vertical direction, relative movement between the radiation resistance sheet and the support may be small. Accordingly, the third hole may have a minor axis S3.

The radiation resistance sheet may include a hole through which at least a portion of the support 31 passes. The hole may include a first hole disposed at a first position. The hole may include a second hole disposed at a second position different from the first position. Optionally, the first hole may be disposed closer to the center of the radiation resistance sheet than the second hole. At least one of distances between an outer circumference of the support and an inner circumference of the first hole may be provided to be greater than at least one of distances between an outer circumference of the second hole and the inner circumference of the first hole. At least one of distances between an outer circumference of the support and the second hole may be greater than at least one of distances between the outer circumference of the support and the first hole. A third hole may be provided between the first hole and the second hole. At least one of distances between the outer circumference of the support and the third hole may be provided to be different from at least one of distances between the outer circumference of the support and the first hole and a distance between the outer circumference of the support and the second hole. At least one of distances between the outer circumference of the support and the third hole may be provided to be smaller than at least one of distances between the outer circumference of the support and the first hole and at least one of distances between the outer circumference of the support and the second hole.

Optionally, the first hole may be disposed in a central portion of the radiation resistance sheet. The second hole may be disposed in a peripheral portion of the radiation resistance sheet. The inner circumference of the first hole may include a portion longer than the inner circumference of the second hole. The first plate may include a portion in which a distance from the first hole is smaller than a distance from the second hole. A minimum distance between the first plate and the first hole may be provided to be smaller than a minimum distance between the first plate and the second hole. At least a portion of the first hole and the second hole may be provided in an open loop shape. At least one of distances between the outer circumference of the support and an inner circumference of the first hole may be provided to be greater than at least one of distances between an outer circumference of the second hole and the inner circumference of the first hole. At least one of distances between the outer circumference of the support and the second hole may be provided to be greater than at least one of distances between the outer circumference of the support and the first hole. A third hole may be provided between the first hole and the second hole. At least one of distances between the outer circumference of the support and the third hole may be provided to be different from at least one of distances between the outer circumference of the support and the first hole and at least one of distances between the outer circumference of the support and the second hole. At least one of distances between the outer circumference of the support and the third hole may be provided to be smaller than at least one of distances between the outer circumference of the support and the first hole and a distance between the outer circumference of the support and the second hole.

Optionally, the first hole may be disposed closer to the center of the radiation resistance sheet than the second hole. The first plate may include a portion in which a distance to the first hole is smaller than a distance to the second hole. A minimum distance between the first plate and the first hole may be provided to be smaller than a minimum distance between the first plate and the second hole. The inner circumference of the first hole may include a portion longer than the inner circumference of the second hole. At least a portion of the first plate and/or the second plate may be provided to have a curvature.

Optionally, at least a portion of the first plate may have a first center of curvature. At least a portion of the second plate may have a second center of curvature. The first center of curvature and the second center of curvature may be provided in the same direction. The direction of the center of curvature may be a direction when the vacuum space 30 is centered. The distance between the portion having the curvature of the first plate and the first center of curvature may be provided to be smaller than the distance between the portion having the curvature of the second plate and the second center of curvature.

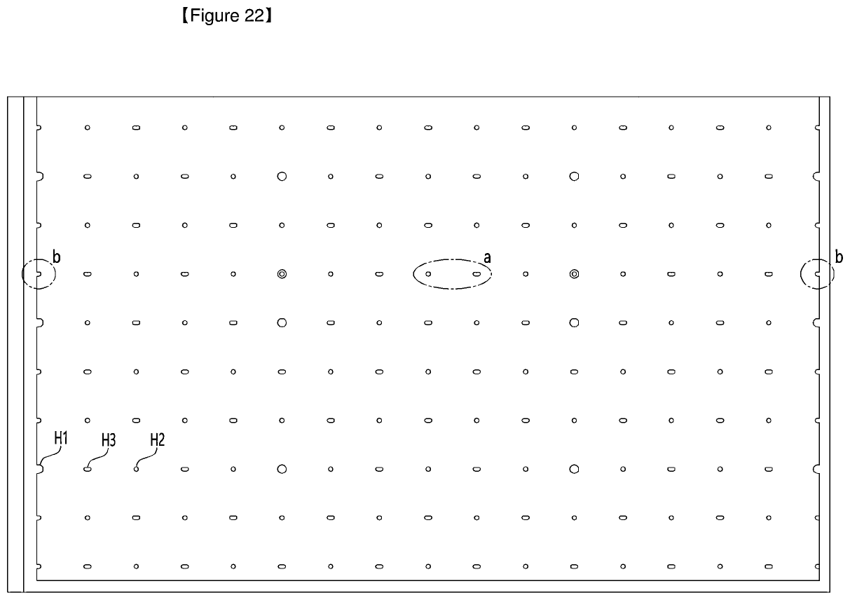

FIG. 22 is a view illustrating a state of observing another example of the radiation resistance sheet in a direction perpendicular to gravity. Referring to FIG. 22, optionally, the first hole H1 may be placed at both ends (b) of the radiation resistance sheet in the left and right direction. At least one of the second hole H2 and the third hole H3 may be placed in the center a of the radiation resistance sheet. Accordingly, it is possible to accurately guide the central portion of the radiation resistance sheet without positional change. A first hole H1 may be placed between both ends b and the center a of the radiation resistance sheet. Accordingly, it is possible to allow the movement of the portion in which the curvature fluctuates.

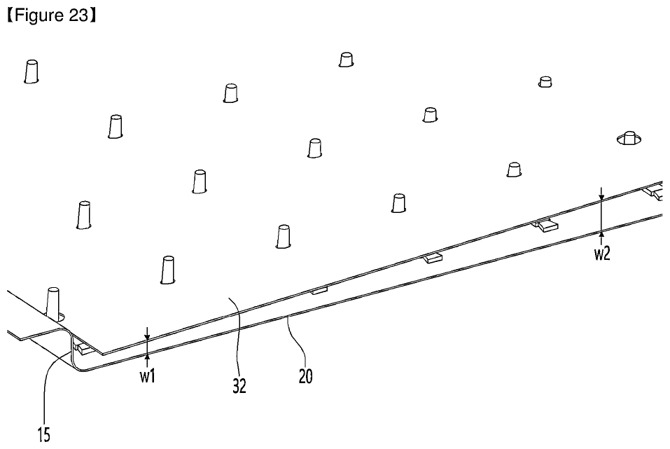

FIG. 23 is a partially cut perspective view illustrating the vacuum adiabatic body in the left and right direction. Referring to FIG. 23, optionally, the distance W1 between the peripheral portion of the second plate 20 and the radiation resistance sheet 32 may be smaller than the distance W2 between the peripheral portion of the second plate 20 and the radiation resistance sheet 32. The distance that the radiation resistance sheet moves along the bar may be longer in the peripheral portion.

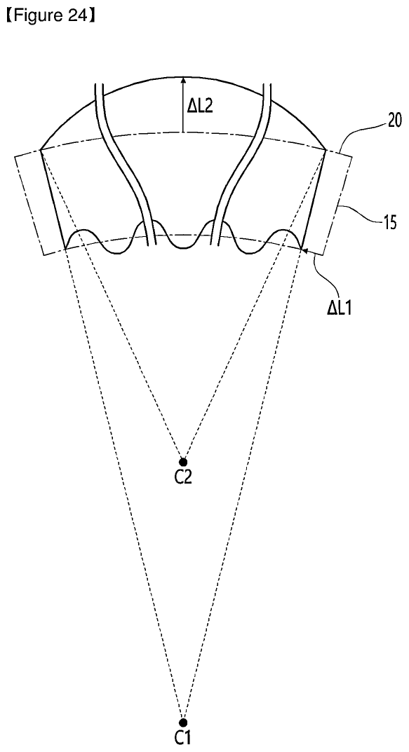

FIG. 24 is a view for explaining the radius of curvature of the first plate and the second plate. Referring to FIG. 24, the virtual line is before vacuum pressure and/or high temperature condition of vacuum exhaust are applied, and the solid line is after vacuum pressure and high temperature condition of vacuum exhaust are applied. Optionally, the vacuum adiabatic body may be deformed by the vacuum pressure and/or high temperature conditions. In response that the vacuum adiabatic body is deformed, since the first plate 10 has a thin thickness, it can be locally deformed a lot. Local here may include deformations within the support's grid. Since the first plate 10 is thin, the first plate 10 may not be changed much overall. Here, the whole may refer to the deformation ΔL1 between both ends of the first plate. Accordingly, the curvature between both ends of the first plate may not be substantially increased. The radius of curvature may not be decreased. Since the second plate is thick, it may be hardly deformed locally. Local here may include deformations within the support's grid. Since the second plate is thick, it can be deformed much overall. Here, the whole may refer to deformation between both ends of the first plate. Accordingly, the curvature ΔL2 between both ends of the second plate may be increased. The radius of curvature may be substantially reduced.

Optionally, the plate can be deformed as follows by the vacuum pressure and high-temperature condition of the vacuum exhaust. The center of curvature C1 of the first plate and the center of curvature C2 of the second plate may be placed in the same direction. A distance from the first plate to the center of curvature C1 of the first plate may be longer than a distance from the second plate to the center of curvature C2 of the second plate.

According to the present disclosure, it is possible to provide a vacuum adiabatic body that can be applied to real life.

1. A vacuum adiabatic body comprising:
a first plate;
a second plate;
a vacuum space disposed between the first plate and the second plate, and configured to be provided in a vacuum state; and
a radiation resistance sheet provided disposed in the vacuum space.

2. The vacuum adiabatic body of claim 1,
wherein a center of curvature of the radiation resistance sheet is provided in a same direction as at least one of the first and second plates, and a radius of curvature of the radiation resistance sheet is greater than a radius of curvature of at least one of the first and second plates.

3. The vacuum adiabatic body of claim 1,
wherein the radiation resistance sheet is separated into at least two components.

4. The vacuum adiabatic body of claim 1,
wherein the radiation resistance sheet is thicker than the first plate.

5. The vacuum adiabatic body of claim 1,
wherein the radiation resistance sheet includes three types of holes.

6. The vacuum adiabatic body of claim 5,
wherein the three types of holes include;
a first hole having a largest size of the three types of holes,
a second hole having a medium size of the three types of holes, and
a third hole having a smallest size of the three types of holes.

7. The vacuum adiabatic body of claim 6,
wherein a size of the first hole is larger than a size of the second hole,
wherein the third hole has a major axis and a minor axis, and the minor axis of the third hole is the smallest among the three types of holes of the radiation resistance sheet,
wherein the major axis of the third hole is larger than the second hole,
wherein the major axis of the third hole is provided in a curvature direction of the vacuum adiabatic body,
wherein the major axis of the third hole is provided in a direction perpendicular to gravity,
wherein the vacuum adiabatic body includes a bar that passes through the hole, and the first hole is configured to receive a large-diameter portion of the bar, and
at least one of the second hole and the third hole is configured to receive a small-diameter portion of the bar.

8. The vacuum adiabatic body of claim 6,
wherein the first hole is provided at a center and both ends of the radiation resistance sheet,
wherein at least one second hole and at least one third hole are alternately between the center and one end of the radiation resistance sheet.

9. The vacuum adiabatic body of claim 6,
wherein the first hole is provided on both ends of the radiation resistance sheet,
wherein the second hole and the third hole are provided in a center of the radiation resistance sheet.

10. A method for manufacturing a vacuum adiabatic body having a seal that seals a first plate and a second plate to provide a vacuum space between the first plate and the second plate, the method comprising:
manufacturing a component to be applied to the vacuum adiabatic body;
assembling the component;
sealing an outer wall of the vacuum space to block the vacuum space from an external space;
exhausting internal air from the vacuum space; and
providing a device configured to use the vacuum adiabatic body;
wherein the exhausting includes bending the vacuum adiabatic body.

11. The method for manufacturing a vacuum adiabatic body of claim 10,
wherein
a center of curvature of the first plate and a center of curvature of the second plate are provided in a same direction, and a distance to the center of curvature of the first plate in the first plate is longer than a distance to the center of curvature of the second plate in the second plate.

12. The method for manufacturing a vacuum adiabatic body of claim 10, further comprising:
providing a radiation resistance sheet in the vacuum space,
wherein a peripheral portion of the radiation resistance sheet moves more than a central portion along a support in the assembling.

13. A vacuum adiabatic body comprising:
a first plate;
a second plate;
a vacuum space disposed between the first plate and the second plate, and configured to be provided in a vacuum state; and
a radiation resistance sheet disposed in the vacuum space and having at least two types of holes configured to receive members.

14. The vacuum adiabatic body of claim 13,
wherein at least one of the two types of holes is configured to receive a bar, and
wherein the two types of holes have different sizes from each other.

15. The vacuum adiabatic body of claim 13,
wherein at least one of the two types of holes is configured to receive a bar, and
wherein the two types of holes has having different shapes from each other.

16. The vacuum adiabatic body of claim 13,
wherein the at least two types of holes include a first hole and a second hole,
wherein a size of the first hole is larger than a size of the second hole, and
wherein the first hole is configured to receive a large-diameter portion of a bar inserted into the first hole.

17. The vacuum adiabatic body of claim 13,
wherein the at least two types of holes include a first hole, a second hole, and a third hole,
wherein a size of the first hole is larger than a size of the second hole, and
wherein at least one of the second hole and the third hole is configured to receive a small-diameter portion of a bar inserted into the at least one of the second hole and the third hole.

18. The vacuum adiabatic body of claim 13,
wherein the at least two types of holes include a first hole, a second hole, and a third hole,
wherein a size of the first hole is larger than a size of the second hole,
wherein the third hole has a major axis and a minor axis, and the minor axis of the third hole is smallest among the other holes of the radiation resistance sheet, and
wherein the major axis of the third hole is larger than the second hole.

19. The vacuum adiabatic body of claim 13,
wherein the at least two types of holes include a first hole, a second hole, and a third hole, and
wherein the third hole has a major axis and a minor axis, and the major axis of the third hole is provided in a curvature direction of the vacuum adiabatic body.

20. The vacuum adiabatic body of claim 13,
wherein the at least two types of holes include a first hole, a second hole, and a third hole, and
wherein the third hole has a major axis and a minor axis, and the major axis of the third hole is provided in a direction perpendicular to gravity.
